(19) United States
(12) Patent Application Publication
(10) Pub. No.: US 2014/0063542 A1
(43) Pub. Date: Mar. 6, 2014

(54) MOBILE TERMINAL DEVICE, IMAGE FORMING METHOD, AND IMAGE PROCESSING SYSTEM

(71) Applicant: Satoshi AOKI, Kanagawa (JP)

(72) Inventor: Satoshi AOKI, Kanagawa (JP)

(73) Assignee: RICOH COMPANY, LTD., Tokyo (JP)

(21) Appl. No.: 13/974,200

(22) Filed: Aug. 23, 2013

(30) Foreign Application Priority Data
Aug. 29, 2012 (JP) 2012-188335

(51) Int. Cl. G06F 3/12

(52) U.S. Cl. CPC G06F 3/1296
USPC 358/1.15

(57) ABSTRACT

A mobile terminal device includes an imaging unit that captures an image; a communication unit; an apparatus information obtaining unit that communicates with and obtains status information from each of a plurality of image forming apparatuses included in the captured image via the communication unit; an image generating unit that generates an augmented reality image by superposing, on the captured image, additional information including the obtained status information for each of the image forming apparatuses; an operations unit that receives an operation on the augmented reality image displayed on a screen; and a distribution unit that distributes a number of pages to be printed among the image forming apparatuses according to the received operation.

### CROSS-REFERENCE TO RELATED APPLICATION

The present application is based upon and claims the benefit of priority of Japanese Patent Application No. 2012-188335, filed on Aug. 29, 2012, the entire contents of which are incorporated herein by reference.

### BACKGROUND OF THE INVENTION

1. Field of the Invention

An aspect of this disclosure relates to a mobile terminal device, an image forming method, and an image processing system.

2. Description of the Related Art

Image forming apparatuses such as printers and multifunction peripherals (MFP) in an office are often connected via a network so that they can communicate with each other and perform a printing process in collaboration with each other. Japanese Laid-Open Patent Publication No. 2009-259129 discloses a technology where networked image forming apparatuses are divided into groups and when an image forming apparatus in a group runs out of paper during a printing process, the printing process is continued by another image forming apparatus in the same group.

Meanwhile, there exists a technology that enables operations on an image forming apparatus based on augmented reality (see, for example, Japanese Laid-Open Patent Publications No. 2012-096448, No. 2011-245792, No. 2008-201101, No. 2012-090077, No. 2010-219879, and No. 2012-103966). Augmented reality (AR) is a technology for generating an augmented reality image by combining a real-world image taken, for example, by a camera and virtual object images.

With the related-art technologies, however, a user needs to select an image forming apparatus from multiple image forming apparatuses taking into account the status of the image forming apparatuses to prevent printing processes from being concentrated on a particular image forming apparatus and thereby prevent the particular image forming apparatus from becoming unable to continue a printing process due to lack of paper and/or toner.

### SUMMARY OF THE INVENTION

In an aspect of this disclosure, there is provided a mobile terminal device including an imaging unit that captures an image; a communication unit; an apparatus information obtaining unit that communicates with and obtains status information from each of a plurality of image forming apparatuses included in the captured image via the communication unit; an image generating unit that generates an augmented reality image by superposing, on the captured image, additional information including the obtained status information for each of the image forming apparatuses; an operations unit that receives an operation on the augmented reality image displayed on a screen; and a distribution unit that distributes a number of pages to be printed among the image forming apparatuses according to the received operation.

### BRIEF DESCRIPTION OF THE DRAWINGS

FIG. 1 is a schematic diagram of an image processing system;

FIG. 2 is a drawing illustrating an exemplary close-range radio communication network;

FIG. 3 is another drawing illustrating an exemplary close-range radio communication network;

FIG. 4 is a drawing illustrating an exemplary hardware configuration of a communication device;

FIG. 5 is a drawing illustrating an exemplary hardware configuration of a mobile terminal device;

FIG. 6 is a drawing illustrating an exemplary hardware configuration of an image forming apparatus;

FIG. 7 is a drawing used to describe a method of detecting a position of an image forming apparatus based on radio field intensity;

FIG. 8 is a drawing illustrating an exemplary configuration of an image processing system;

FIG. 9A is a drawing illustrating an exemplary augmented reality image displayed on a mobile terminal device according to a first embodiment;

FIG. 9B is a drawing illustrating another exemplary augmented reality image displayed on a mobile terminal device according to the first embodiment;

FIG. 9C is a drawing illustrating another exemplary augmented reality image displayed on a mobile terminal device according to the first embodiment;

FIG. 9D is a drawing illustrating another exemplary augmented reality image displayed on a mobile terminal device according to the first embodiment;

FIG. 9E is a drawing illustrating another exemplary augmented reality image displayed on a mobile terminal device according to the first embodiment;

FIG. 9F is a drawing illustrating another exemplary augmented reality image displayed on a mobile terminal device according to the first embodiment;

FIG. 9G is a drawing illustrating another exemplary augmented reality image displayed on a mobile terminal device according to the first embodiment;

FIG. 10A is a drawing illustrating an exemplary augmented reality image displayed on a mobile terminal device according to a second embodiment;

FIG. 10B is a drawing illustrating an exemplary augmented reality image displayed on a mobile terminal device according to the second embodiment;

FIG. 10C is a drawing illustrating another exemplary augmented reality image displayed on a mobile terminal device according to the second embodiment;

FIG. 10D is a drawing illustrating another exemplary augmented reality image displayed on a mobile terminal device according to the second embodiment;

FIG. 10E is a drawing illustrating another exemplary augmented reality image displayed on a mobile terminal device according to the second embodiment;

FIG. 10F is a drawing illustrating another exemplary augmented reality image displayed on a mobile terminal device according to the second embodiment;

FIG. 10G is a drawing illustrating another exemplary augmented reality image displayed on a mobile terminal device according to the second embodiment;

FIG. 10H is a drawing illustrating another exemplary augmented reality image displayed on a mobile terminal device according to the second embodiment;

FIG. 10I is a drawing illustrating another exemplary augmented reality image displayed on a mobile terminal device according to the second embodiment;

FIG. 11A is a drawing illustrating an exemplary augmented reality image displayed on a mobile terminal device according to a third embodiment;

FIG. 11B is a drawing illustrating an exemplary augmented reality image displayed on a mobile terminal device according to the third embodiment;

FIG. 11C is a drawing illustrating another exemplary augmented reality image displayed on a mobile terminal device according to the third embodiment;

FIG. 11D is a drawing illustrating another exemplary augmented reality image displayed on a mobile terminal device according to the third embodiment;

FIG. 11E is a drawing illustrating another exemplary augmented reality image displayed on a mobile terminal device according to the third embodiment;

FIG. 11F is a drawing illustrating another exemplary augmented reality image displayed on a mobile terminal device according to the third embodiment;

FIG. 11G is a drawing illustrating another exemplary augmented reality image displayed on a mobile terminal device according to the third embodiment;

FIG. 12 is a sequence chart illustrating a process performed to exchange information among communication devices, image forming apparatuses, and a management server;

FIG. 13 is a sequence chart illustrating an exemplary process for displaying a print reception screen according to the first and second embodiments;

FIG. 14 is a sequence chart illustrating an exemplary process for displaying a print reception screen according to the third embodiment;

FIG. 15 is a sequence chart illustrating an exemplary printing process according to the first embodiment;

FIG. 16 is a sequence chart illustrating an exemplary printing process according to the second embodiment;

FIG. 17 is a sequence chart illustrating an exemplary printing process according to the third embodiment; and

FIG. 18 is a flowchart illustrating an exemplary algorithm for determining how to distribute the number of pages to be printed among image forming apparatuses.

### DESCRIPTION OF THE PREFERRED EMBODIMENTS

Preferred embodiments of the present invention are described below with reference to the accompanying drawings.

1. OUTLINE

2. FUNCTIONS

3. FIRST EMBODIMENT

4. SECOND EMBODIMENT

5. THIRD EMBODIMENT

### 1. Outline

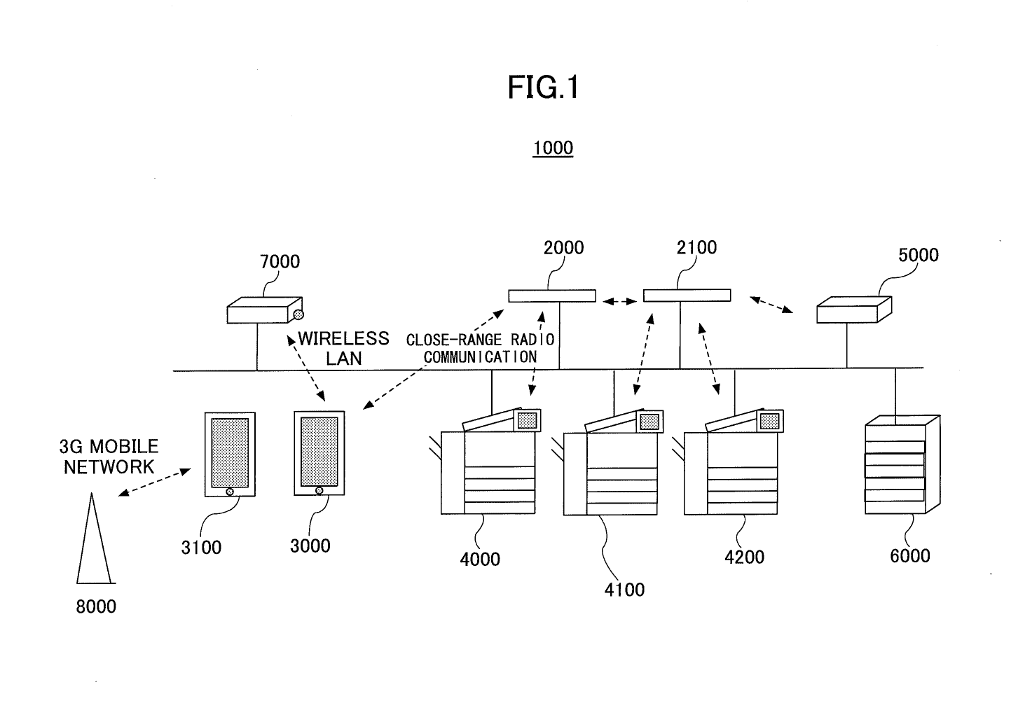

The outline of an image processing system 1000 according to an embodiment is described below with reference to FIG. 1. As illustrated by FIG. 1, the image processing system 1000 may include communication devices 2000 and 2100; mobile terminal devices 3000 and 3100; image forming apparatuses 4000, 4100, and 4200; a gateway 5000, a management server 6000, a wireless access point 7000, and a base station 8000 that can communicate with each other via a local area network (LAN) and/or a wide area network (WAN). Also, as described in more detail later, the communication devices 2000 and 2100, the mobile terminal devices 3000 and 3100, the image forming apparatuses 4000, 4100, and 4200, and the gateway 5000 can form a close-range radio communication network such as a personal area network (PAN). In other words, these apparatuses can communicate with each other without using a local area network and a wide area network. Further, the mobile terminal devices 3000 and 3100 can communicate with other apparatuses in FIG. 1 via a communication network such as a 3G mobile network and an external network such as the Internet.

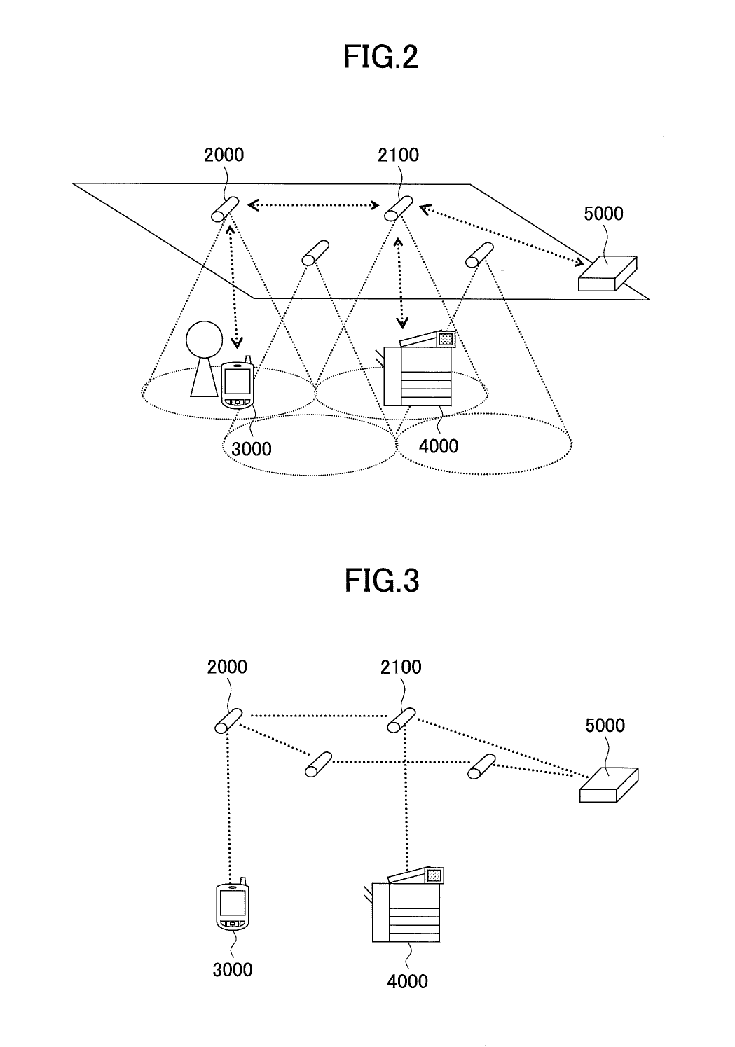

The communication devices 2000 and 2100 may be, for example, embedded in light-emitting diode (LED) lighting equipment attached to a ceiling and may form a PAN based on, for example, ZigBee (registered trademark). An exemplary configuration of a PAN is described later with reference to FIGS. 2 and 3. The communication devices 2000 and 2100 can transmit an indoor positioning signal according to, for example, an indoor messaging system (IMES) standard. The indoor positioning signal may include positional information including latitude, longitude, and altitude.

Each of the mobile terminal devices 3000 and 3100 may be implemented by a smart device such as a smartphone or a tablet personal computer (PC), or an information terminal such as a notebook PC or a personal digital assistant (PDA). Below, for brevity, the mobile terminal device 3000 is mainly used for descriptions. However, the descriptions may also be applied to the mobile terminal device 3100. The mobile terminal device 3000 can obtain status information of the image forming apparatuses 4000, 4100, and 4200 via, for example, the PAN. Also, the mobile terminal device 3000 may include an imaging unit such as a camera and can generate an augmented reality image where additional information represented by text and/or images is superposed on a real-world image captured by the imaging unit. For example, the mobile terminal device 3000 analyzes a captured real-world image and identifies the image forming apparatuses 4000, 4100, and 4200 in the real-world image. A known technology such as markerless augmented reality may be used to identify the image forming apparatuses 4000, 4100, and 4200 in the real-world image. Also, even when the shapes of the image forming apparatuses 4000, 4100, and 4200 are not known, the mobile terminal device 3000 can identify the image forming apparatuses 4000, 4100, and 4200 by detecting tags (or markers) in a captured real-world image that are included in the image forming apparatuses 4000, 4100, and 4200. Thus, any known technology may be used to identify the image forming apparatuses 4000, 4100, and 4200 in a captured real-world image. When the image forming apparatuses 4000, 4100, and 4200 are uniquely identified in the analyzed real-world image, the mobile terminal device 3000 communicates with the identified image forming apparatuses 4000, 4100, and 4200 using connection information (e.g., network addresses on a PAN) associated with the image forming apparatuses 4000, 4100, and 4200. The mobile terminal device 3000 thereby obtains status information (e.g., the amount of remaining toner and the amount of remaining paper (or the number of remaining paper sheets)) of each of the identified image forming apparatuses 4000, 4100, and 4200. The mobile terminal device 3000 can superpose additional information including the obtained status information on the real-world image to generate an augmented reality image and display the augmented reality image on a screen.

As described above, the mobile terminal device 3000 can display, for the user, an augmented reality image including additional information obtained from the image forming apparatuses 4000, 4100, and 4200. Also, the mobile terminal device 3000 can display additional information of the image forming apparatuses 4000, 4100, and 4200 such that the size of the displayed additional information becomes smaller as the distance from the mobile terminal device 3000 increases. The mobile terminal device 3000 may obtain positional information indicating the positions of the image forming apparatuses 4000, 4100, and 4200 via, for example, the PAN together with the status information. On the other hand, the mobile terminal device 3000 obtains positional information indicating its own position based on a positioning signal transmitted from one of the communication devices 2000 and 2100. When a print request is received from the user via the displayed augmented reality image, the mobile terminal device 3000 distributes the number of pages to be printed among one or more of the image forming apparatuses 4000, 4100, and 4200 based on their status information (i.e., determines how many pages need to be printed by each selected image forming apparatus).

The mobile terminal device 3000 can also obtain, from the management server 6000, connection information of image forming apparatuses that are outside of an imaging area that the imaging unit can capture, and communicate with those image forming apparatuses using the connection information to obtain their status information.

Each of the image forming apparatuses 4000, 4100, and 4200 can perform printing processes and may be implemented, for example, by a laser printer or multifunction peripheral (MFP). Each of the image forming apparatuses 4000, 4100, and 4200 retains status information such as the amount of remaining toner and the amount of remaining paper. Similarly to the mobile terminal device 3000, each of the image forming apparatuses 4000, 4100, and 4200 can obtain positional information indicating its own position based on a positioning signal transmitted from one of the communication devices 2000 and 2100. In response to a request from the mobile terminal device 3000 (or 3100), each of the image forming apparatuses 4000, 4100, and 4200 can transmit the status information and the positional information to the mobile terminal device 3000 (or 3100). Also, in response to a request from the management server 6000, each of the image forming apparatuses 4000, 4100, and 4200 can transmit the connection information such as an IP address and the positional information to the management server 6000.

The gateway 5000 forms a PAN with the communication devices 2000 and 2100, the mobile terminal devices 3000 and 3100, and the image forming apparatuses 4000, 4100, and 4200. Details of the PAN are described later.

The management server 6000 manages the positional information and the connection information (e.g., IP addresses) of all image forming apparatuses (including the image forming apparatuses 4000, 4100, and 4200) belonging to the image processing system 1000. In response to a request from the mobile terminal device 3000 (or 3100), the management server 6000 provides the connection information of the image forming apparatuses being managed.

The wireless access point 7000 provides the mobile terminal devices 3000 and 3100 with access to a wireless LAN according to, for example, the IEEE 802.11 standards.

The base station 8000 provides the mobile terminal devices 3000 and 3100 with access to, for example, a 3G mobile network.

Next, an exemplary configuration of a close-range radio communication network or a PAN is described with reference to FIGS. 2 and 3. FIG. 2 illustrates some of the apparatuses in FIG. 1 that constitute the PAN. In FIG. 2, cone shapes represented by dotted lines indicate ranges that indoor positioning signals transmitted from the corresponding communication devices (including the communication devices 2000 and 2100) can reach. FIG. 3 also illustrates the apparatuses that constitute the PAN.

In this example, for descriptive purposes, it is assumed that the communication devices 2000 and 2100, the mobile terminal device 3000, the image forming apparatus 4000, and the gateway 5000 constitute the PAN. When the PAN is based on ZigBee (registered trademark), the communication devices 2000 and 2100 function as ZigBee routers (i.e., devices that relay data between other ZigBee devices).

The gateway 5000 connects the PAN and the LAN with each other and relays data from the PAN to the LAN. The gateway 160 also includes a function for managing the configuration of the PAN.

As illustrated by FIGS. 2 and 3, the mobile terminal device 3000 and the image forming apparatus 4000 are connected to end points of the PAN. When ZigBee (registered trademark) is used for close-range radio communications, the mobile terminal device 3000 and the image forming apparatus 4000 function as ZigBee end devices (i.e., devices connected to ZigBee routers or a ZigBee coordinator and having no data relay function). The gateway 5000 functions as a ZigBee coordinator (i.e., a device for starting, forming, and managing a ZigBee network, only one ZigBee coordinator is provided in a ZigBee network).

With the image processing system 1000 of the present embodiment, it is possible to display an augmented reality image where status information indicating, for example, the amount of remaining toner and the amount of remaining paper is superposed on a captured real-world image. Also, the mobile terminal device 3000 (3100) of the present embodiment can distribute the number of pages to be printed among one or more of the image forming apparatuses 4000, 4100, and 4200 based on their status information. Thus, the present embodiment makes it possible to prevent a situation where paper and toner of a particular image forming apparatus are used intensively and thereby makes it possible to use resources of multiple image forming apparatuses in a balanced manner (or evenly).

### 2. Functions

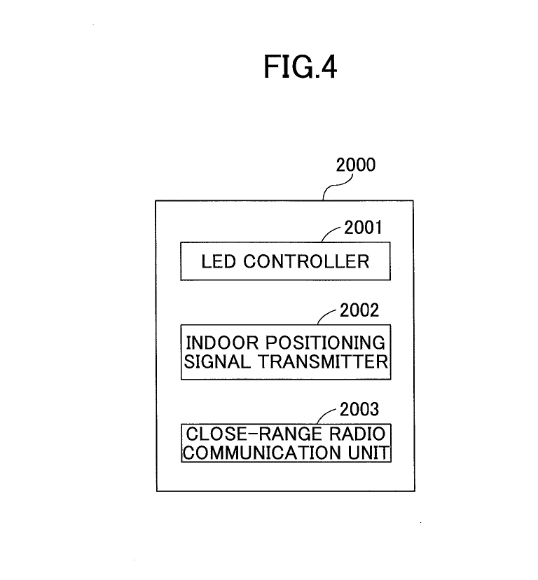

Next, exemplary hardware and functional configurations of the communication device 2000, the mobile terminal device 3000, and the image forming apparatus 4000 are described with reference to FIGS. 4 through 6. The communication device 2100, the mobile terminal device 3100, and the image forming apparatuses 4100 and 4200 have substantially the same configurations as those of the communication device 2000, the mobile terminal device 3000, and the image forming apparatus 4000.

FIG. 4 is a drawing illustrating an exemplary configuration of the communication device 2000. The communication device 2000 may include an LED controller 2001, an indoor positioning signal transmitter 2002, and a close-range radio communication unit 2003.

The LED controller 2001 controls the luminous intensity of lighting equipment such as an LED fluorescent tube where the communication device 2000 is embedded.

The indoor positioning signal transmitter 2002 transmits an indoor positioning signal that includes positional information and is used inside of a building where a radio signal from a global positioning system (GPS) satellite cannot reach. The indoor positioning signal has substantially the same signal format as that of a radio signal from a GPS satellite. For example, the indoor positioning signal transmitter 2002 transmits the indoor positioning signal according to an IMES standard. Positional information including longitude and latitude coordinates and an altitude indicating the position where the communication device 2000 is installed is stored in advance in the indoor positioning signal transmitter 2002.

The close-range radio communication unit 2003 performs close-range radio communications with the mobile terminal devices 3000 and 3100 and the image forming apparatuses 4000, 4100, and 4200. The close-range radio communications may be performed according to, for example, Bluetooth (registered trademark) or ZigBee (registered trademark).

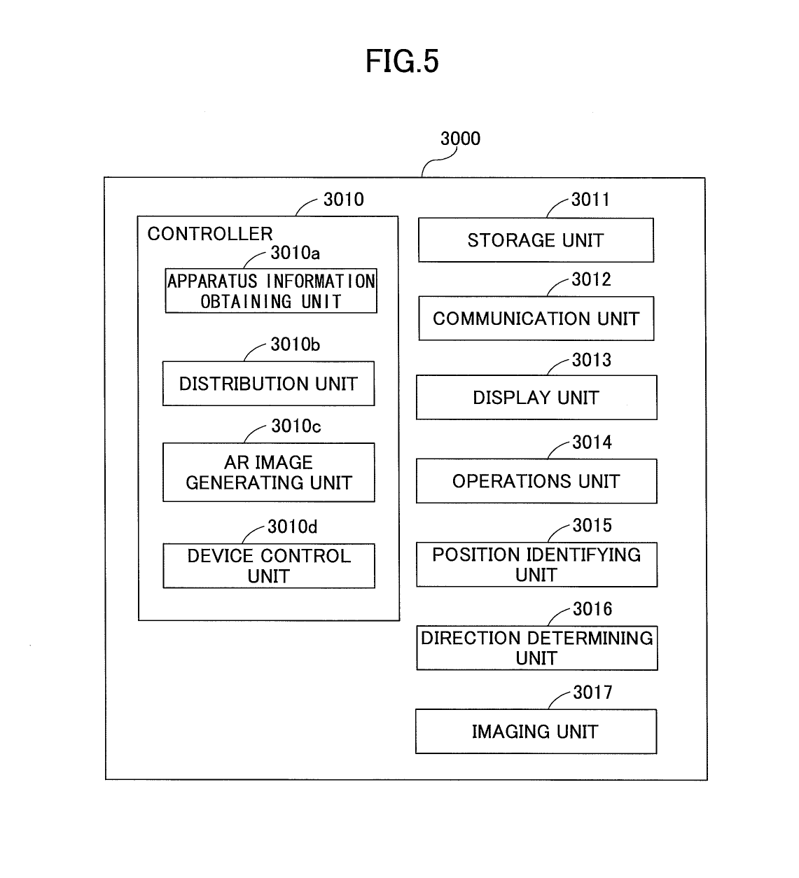

FIG. 5 is a drawing illustrating an exemplary configuration of the mobile terminal device 3000. The mobile terminal device 3000 may include a controller 3010, a storage unit 3011, a communication unit 3012, a display unit 3013, an operations unit 3014, a position identifying unit 3015, a direction determining unit 3016, and an imaging unit 3017.

The controller 3010 may include a central processing unit (CPU) and memories such as a random access memory (RAM) and a read-only memory (ROM), and controls operations of the mobile terminal device 3000. The controller 3010 may function as an apparatus information obtaining unit 3010a, a distribution unit 3010b, an augmented reality (AR) image generating unit 3010c, and a device control unit 3010d. The apparatus information obtaining unit 3010a communicates with the image forming apparatuses 4000, 4100, and 4200 and the management server 6000 to obtain positional information, connection information such as IP addresses, and status information including the amount of remaining toner, the amount of remaining paper, and the progress status of print jobs of the respective image forming apparatuses 4000, 4100, and 4200. The distribution unit 3010b distributes the number of pages to be printed among the image forming apparatuses 4000, 4100, and 4200 according to the amounts of remaining toner and paper, to execute a print job. The AR image generating unit 3010c identifies objects in an image taken by a camera and generates an augmented reality image. The device control unit 3010d controls the entire mobile terminal device 3000.

The storage unit 3011 may be implemented by, for example, a hard disk drive (HDD) or a semiconductor memory such as a flash memory, and stores, for example, positional information, connection information, and status information of the image forming apparatuses 4000, 4100, and 4200.

The communication unit 3012 is a network interface such as a network interface card (NIC) or a modem. The communication unit 3012 is connected to a network via the wireless access point 7000 or the base station 8000, and communicates with the image forming apparatuses 4000, 4100, and 4200 and the management server 6000. The communication unit 3012 can also perform communications according to a close-range radio communication standard such as Bluetooth or ZigBee.

The display unit 3013 may be implemented by, for example, a liquid crystal display (LCD) or an organic electroluminescence (EL) display. The display unit 3013 displays, for example, an augmented reality image where an operations panel and/or the print job status and the amounts of remaining toner and paper of the image forming apparatuses 4000, 4100, and 4200 are superposed on a real-world image.

The operations unit 3014 may be implemented, for example, by hardware keys and/or a touch panel on the display unit 3013. The operations unit 3014 receives operations on a displayed operations panel and thereby allows the user to enter instructions to the image forming apparatuses 4000, 4100, and 4200.

The position identifying unit 3015 receives a GPS signal or an indoor positioning signal (e.g., IMES signal) and thereby determines the current position (latitude, longitude, and altitude) of the mobile terminal device 3000.

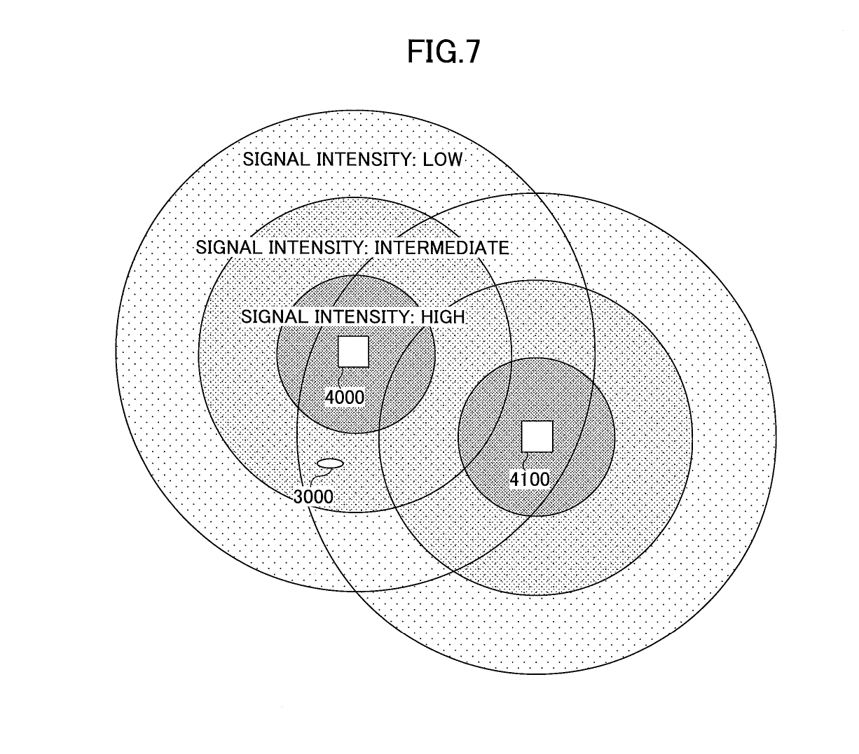

The direction determining unit 3016 determines the direction (or orientation) of the mobile terminal device 3000 according to an autonomous positioning technology using a gyroscope and an acceleration sensor. When the image forming apparatuses 4000, 4100, and 4200 are configured to transmit electromagnetic waves (e.g., radio signals according to, for example, a wireless LAN or ZigBee standard) and the mobile terminal 3000 is capable of receiving the electromagnetic waves, the mobile terminal 3000 may measure the intensities of the electromagnetic waves and determine its position and direction based on the measured intensities. FIG. 7 illustrates an example where the mobile terminal device 3000 receives electromagnetic waves transmitted from the image forming apparatuses 4000 and 4100. In the example of FIG. 7, the intensity (signal intensity) of the electromagnetic wave received from the image forming apparatus 4000 is intermediate and the intensity of the electromagnetic wave received from the image forming apparatus 4100 is low. Therefore, in this case, the mobile terminal device 3000 determines that the image forming apparatus 4000 is closer to the mobile terminal device 3000 than the image forming apparatus 4100.

The imaging unit 3017 may be implemented, for example, by a charge coupled device (CCD) camera or a complementary metal-oxide semiconductor (CMOS) camera, and can capture an image (real-world image) of an actual scene including the image forming apparatuses 4000, 4100, and 4200.

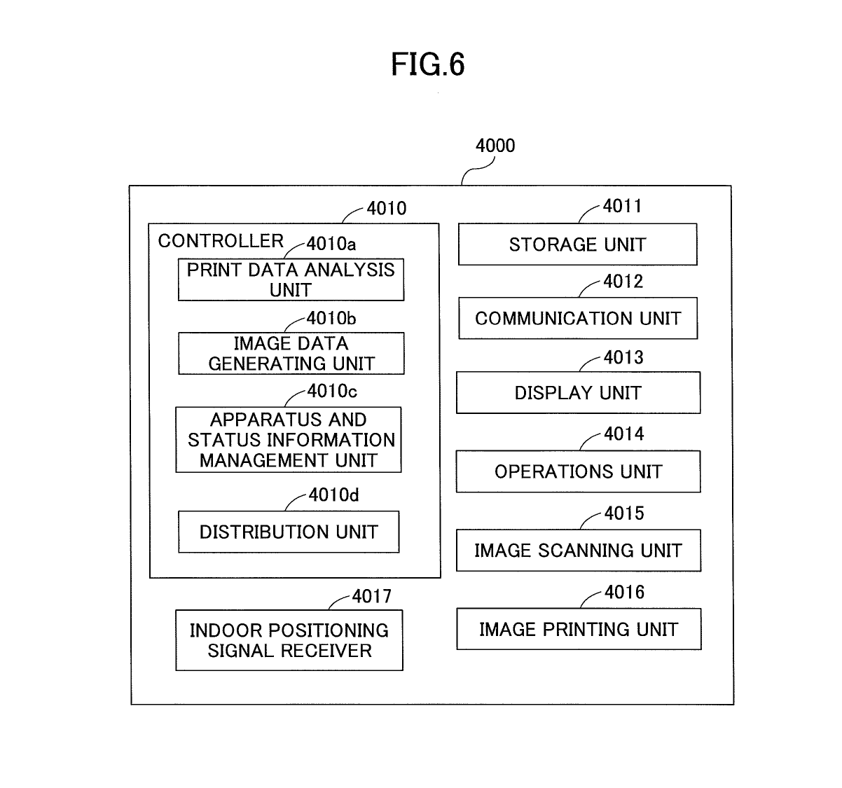

FIG. 6 is a drawing illustrating an exemplary configuration of the image forming apparatus 4000. The image forming apparatus 4000 may include a controller 4010, a storage unit 4011, a communication unit 4012, a display unit 4013, an operations unit 4014, an image scanning unit 4015, an image printing unit 4016, and an indoor positioning signal receiver 4017.

The controller 4010 may include a central processing unit (CPU) and memories such as a random access memory (RAM) and a read-only memory (ROM), and controls operations of the entire image forming apparatus 4000. The controller 4010 may function as a print data analysis unit 4010a, an image data generating unit 4010b, an apparatus and status information management unit 4010c, and a distribution unit (redistribution unit) 4010d. The print data analysis unit 4010a analyzes actual data (or print data) written in, for example, a printer command language (PCL) or a page description language (PDL). The image data generating unit 4010b generates image data by rasterizing (or bitmapping) the actual data based on the analysis results. The apparatus and status information management unit 4010c manages status information including the progress status of print jobs and the amounts of remaining toner and paper of the image forming apparatus, and connection information such as an IP address of the image forming apparatus 4000. The distribution unit 4010d redistributes the number of pages to be printed in an ongoing print job to other image forming apparatuses when print jobs are received from multiple users.

The storage unit 4011 may be implemented by, for example, a hard disk drive (HDD) or a semiconductor memory such as a flash memory, and stores, for example, connection information, status information, and print setting information of the image forming apparatus 4000.

The communication unit 4012 is a network interface such as an NIC or a modem, and communicates with the communication devices 2000 and 2100 and the mobile terminal devices 3000 and 3100 according to a standard such as the Ethernet (registered trademark). The communication unit 4012 may also be configured to perform communications according to a close-range radio communication standard such as Bluetooth or ZigBee.

The display unit 4013 may be implemented, for example, by an LCD or an organic EL display and displays various screens, for example, for copy, scan, print, and facsimile functions.

The operations unit 4014 may be implemented, for example, by hardware keys and/or a touch panel on the display unit 4013, and allows the user to enter instructions to use, for example, copy, scan, print, and facsimile functions.

The image scanning unit 4015 optically scans a document on a document table to obtain image data, and may include a light source for illuminating the document, an image sensor such as a CCD sensor for converting light reflected from the document into an electric signal, and an analog-to-digital (AD) converter for converting the electric (analog) signal into a digital signal.

The image printing unit 4016 transfers image data onto paper. In the image printing unit 4016, for example, a photosensitive drum is charged by a charging unit, the charged photosensitive drum is illuminated by an exposing unit according to image data to form an electrostatic latent image, the electrostatic latent image is developed by a developing unit with toner to form a toner image, the toner image is transferred from the photosensitive drum to a transfer belt (primary transfer) and transferred from the transfer belt to paper (secondary transfer), and then the transferred toner image is fused by a fusing unit onto the paper. The image printing unit 4016 may also perform processing such as folding, binding, and stapling.

The indoor positioning signal receiver 4017 receives an indoor positioning signal transmitted from the indoor positioning signal transmitter 2002 of the communication device 2000 (or 2100) and obtains positional information indicating the current position of the image forming apparatus 4000 based on the received indoor positioning signal.

### 3. First Embodiment

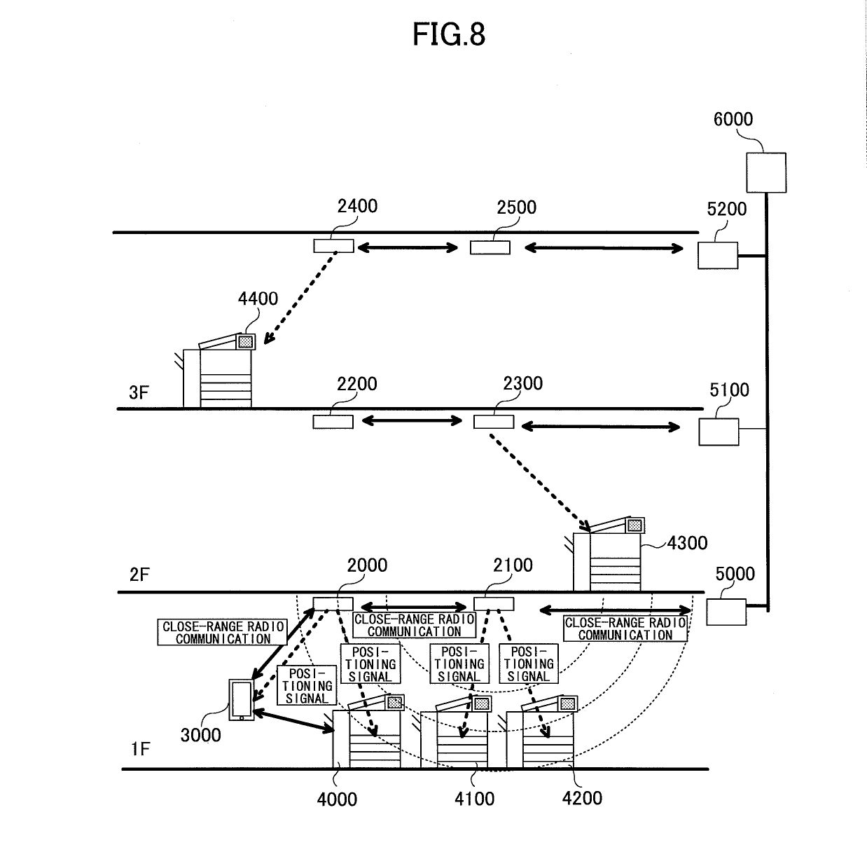

A first embodiment is described below. FIG. 8 is a drawing illustrating an exemplary configuration of the image processing system 1000 that is common to the first embodiment and second and third embodiments described later. FIG. 8 illustrates a positional relationship among image forming apparatuses, communication devices, gateways, a management server, and mobile terminal devices installed in first through third floors of a three-story building. In FIG. 8, it is assumed that a PAN is formed by a gateway installed in each floor.

In the first floor, the communication devices 2000 and 2100, the image forming apparatuses 4000, 4100, and 4200, and the gateway 5000 are installed. Also in the first floor, there exists the mobile terminal device 3000 carried by a user. The image forming apparatus 4000 receives an indoor positioning signal transmitted from the communication device 2000 and obtains positional information based on the received indoor positioning signal, and the image forming apparatuses 4100 and 4200 receive an indoor positioning signal transmitted from the communication device 2100 and obtain positional information based on the received indoor positioning signal. Although the image forming apparatus 4100 can also receive the indoor positioning signal transmitted from the communication device 2000, the image forming apparatus 4100 selects the indoor positioning signal transmitted from the nearest communication device 2100 based on the received signal intensities of the indoor positioning signals and obtains positional information based on the selected indoor positioning signal. Each of the image forming apparatuses 4000, 4100, and 4200 transmits the obtained positional information and its connection information (e.g., an IP address) via the PAN or a LAN to the management server 6000.

The apparatuses and devices installed in the first floor can communicate with each other via the PAN without using the LAN. Meanwhile, the mobile terminal device 3000 currently located in the first floor cannot join a PAN being managed by a gateway 5100 installed in the second floor, and therefore needs use the LAN to communicate with an image forming apparatus 4300 in the second floor. However, because the mobile terminal device 3000 does not initially have connection information necessary to connect to the image forming apparatus 4300, the mobile terminal device 3000 needs to obtain the connection information from the management server 6000. The mobile terminal device 3000 can connect to the management server 6000 via the PAN or the LAN to obtain the connection information and communicate with the image forming apparatus 4300 on the second floor using the obtained connection information. In a similar manner, the mobile terminal device 3000 can also communicate with an image forming apparatus 4400 installed in the third floor.

In the second floor, communication devices 2200 and 2300, the image forming apparatuses 4300, and the gateway 5100 are installed. In the third floor, communication devices 2400 and 2500, the image forming apparatuses 4400, and a gateway 5200 are installed. The apparatuses and devices in each floor can only connect to a PAN being managed by the corresponding gateway (5000, 5100, or 5200) installed in the floor. The image forming apparatus 4300 installed in the second floor receives an indoor positioning signal transmitted from the communication device 2300. The image forming apparatus 4400 installed in the third floor receives an indoor positioning signal transmitted from the communication device 2400.

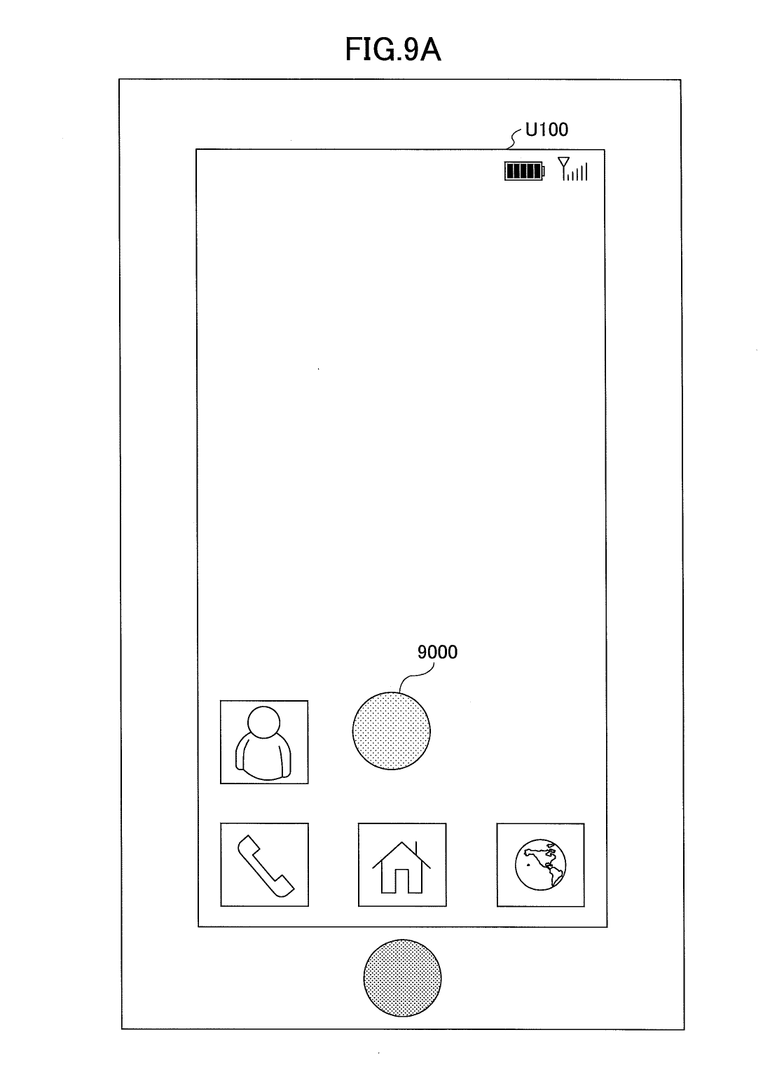

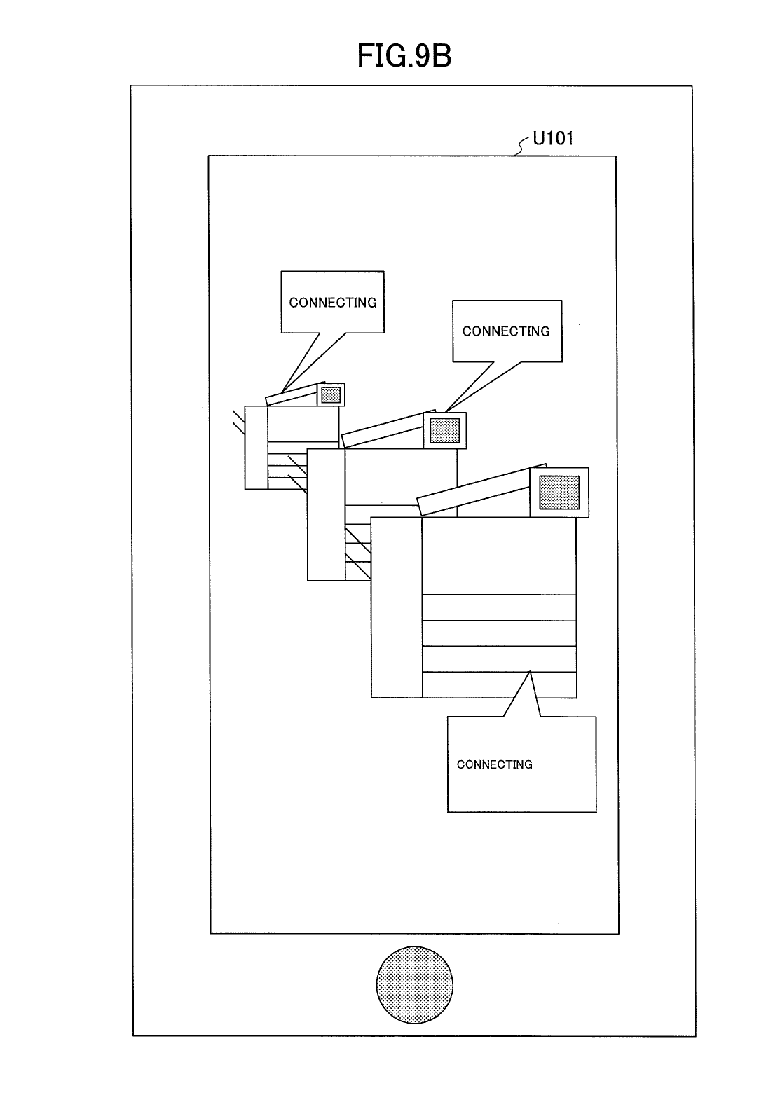

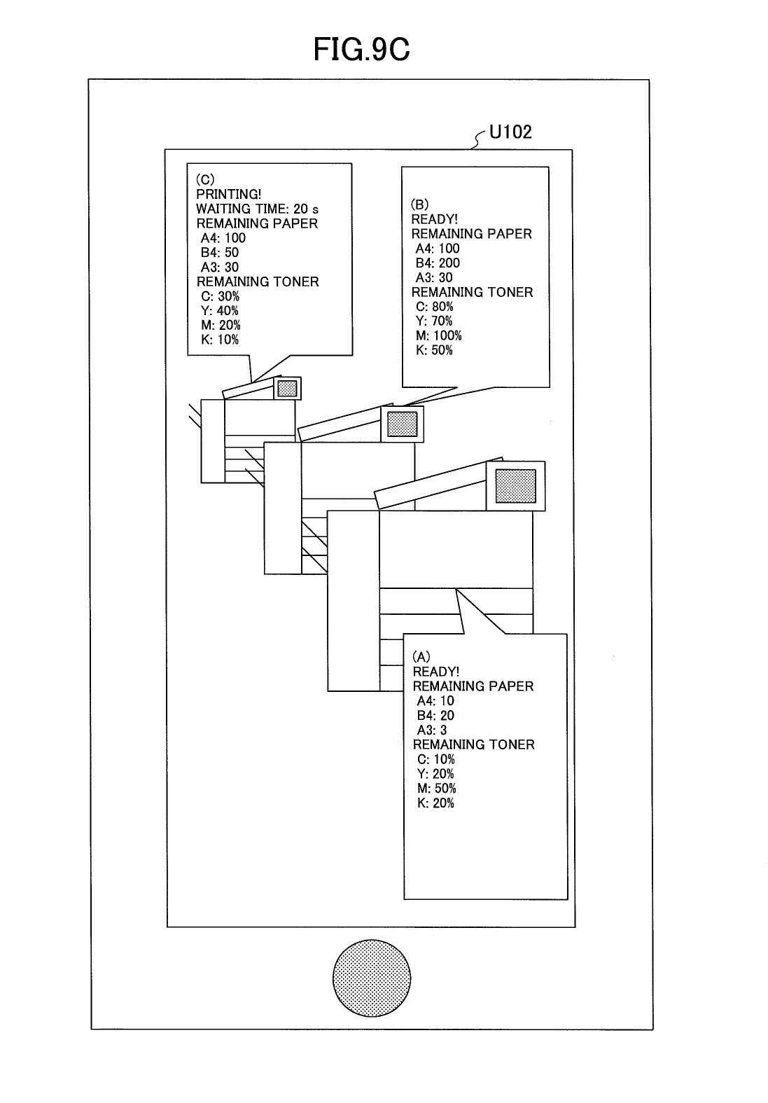

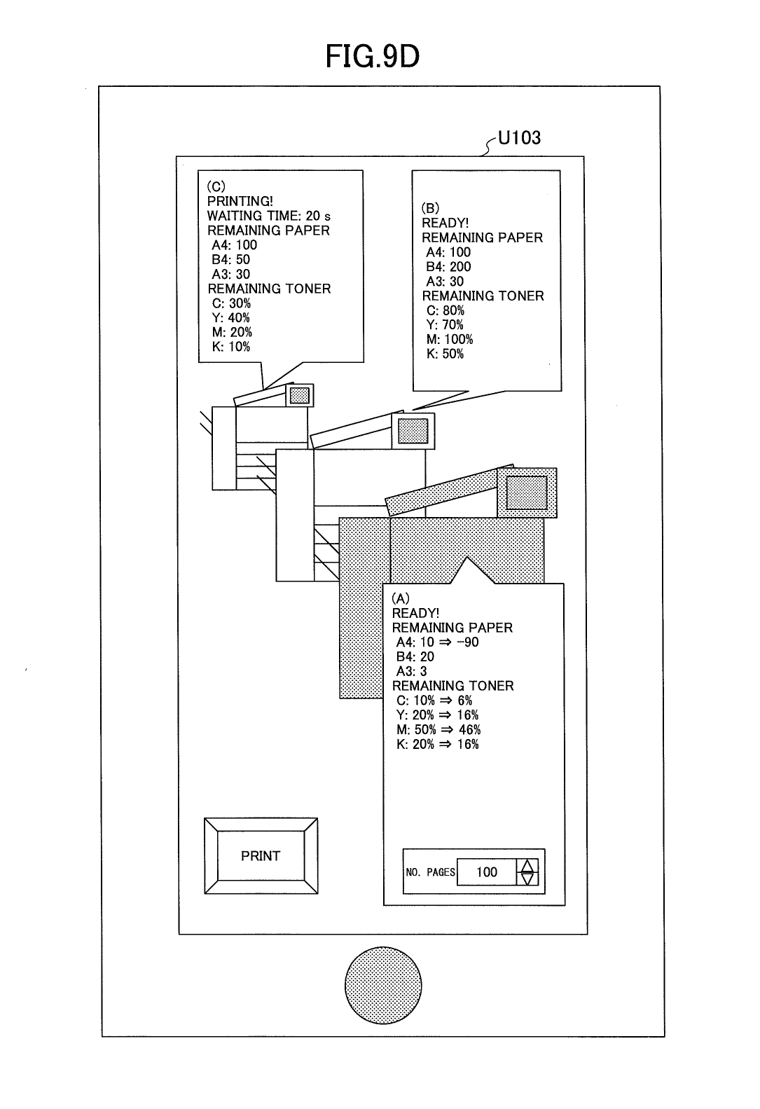

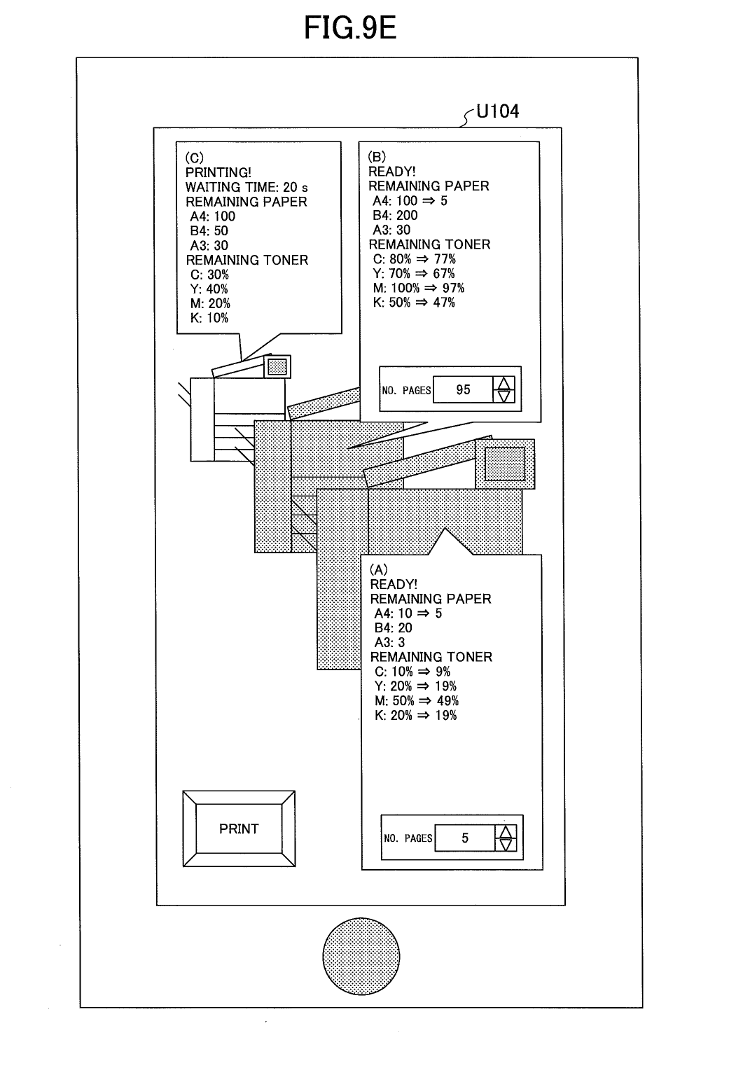

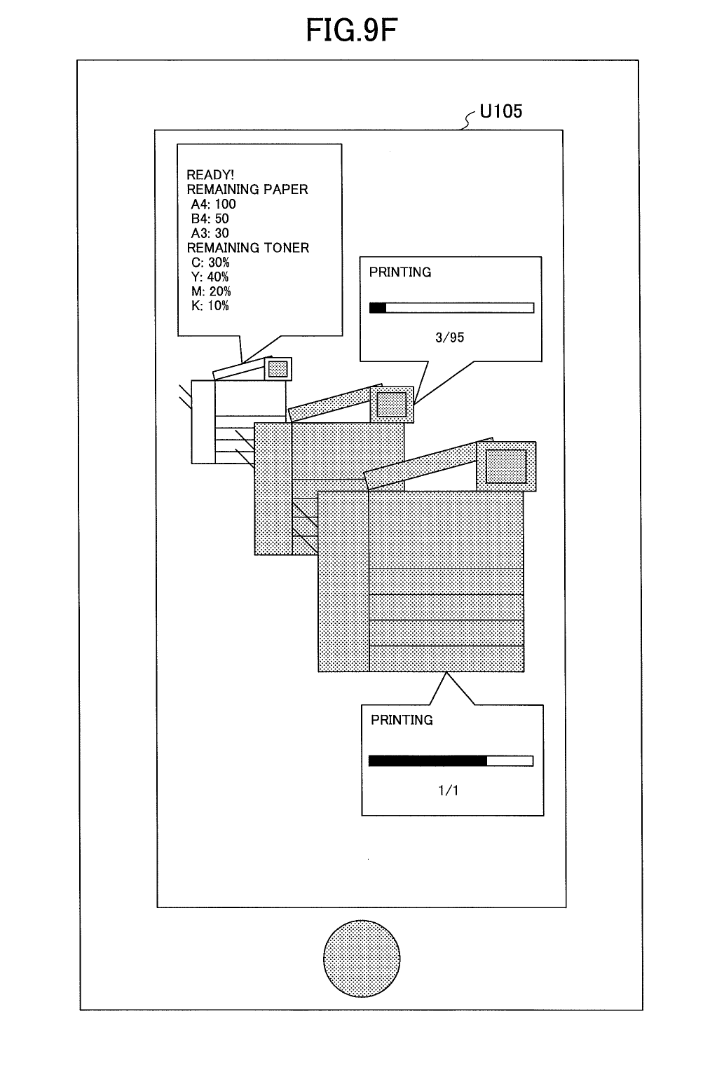

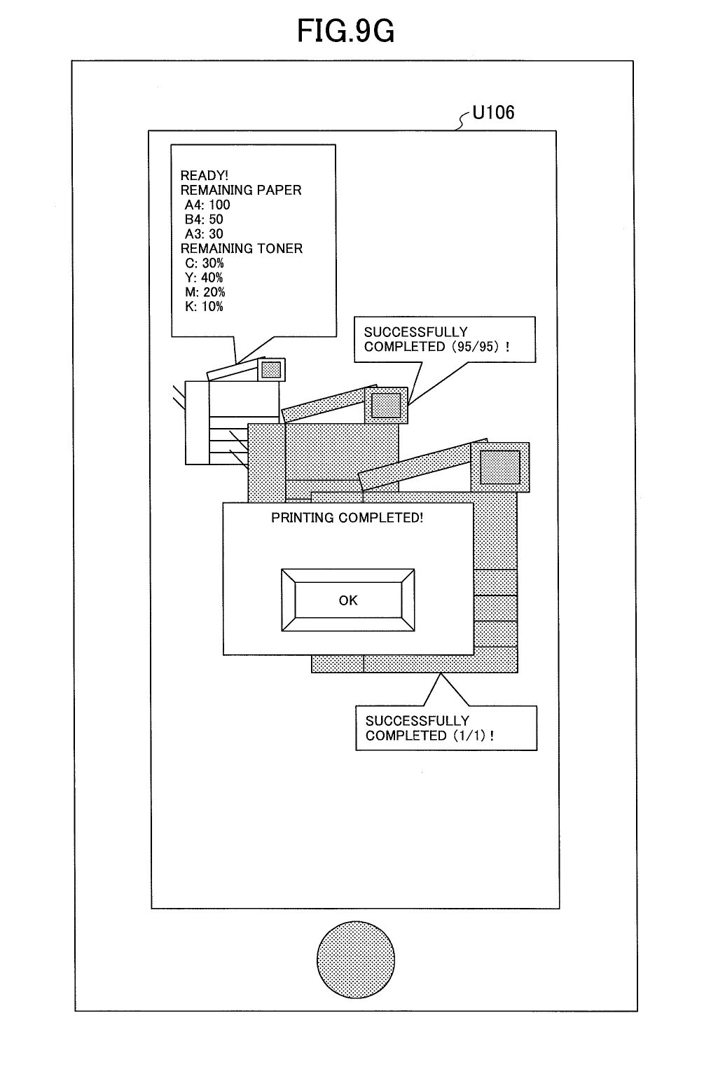

FIGS. 9A through 9G are drawings illustrating exemplary augmented reality images displayed on the mobile terminal device 3000 according to the first embodiment.

In FIGS. 9A through 9G, it is assumed that the mobile terminal device 3000 is a smartphone. A screen U100 in FIG. 9A is an example of a standby screen. The user can start an application 9000 for using the image processing system 1000 by touching an icon of the application 9000 on the screen U100. When the application 9000 is started, a screen U101 is displayed as illustrated by FIG. 9B.

The screen U101 is displayed while the mobile terminal device 3000 is trying to connect to a PAN (or a close-range radio communication network) to which image forming apparatuses identified in a captured image are connected. Messages indicating that the image forming apparatuses are trying to connect to the PAN are displayed on the screen U101.

When the image forming apparatuses are connected to the PAN and status information including print job status and the amounts of remaining toner and paper are obtained, a screen U102 is displayed as illustrated by FIG. 9C. On the screen U102, additional information including messages and the obtained status information is displayed in a balloon for each of the image forming apparatuses.

On a screen U103 illustrated in FIG. 9D, the closest image forming apparatus (A) is selected. In FIG. 9D, it is assumed that the user is going to print one hundred pages in a file (or document). Because only the image forming apparatus (A) is selected on the screen U103, “100” (i.e., the entire number of pages) is displayed as the number of pages to be printed on the image forming apparatus (A). The number of pages is also a part of the additional information. The additional information may also include estimated amounts of remaining toner and paper after printing. The estimated amounts of remaining toner and paper can be obtained based on the details of print data to be printed. The amount of toner to be consumed by printing print data can be calculated based on parameters such as a paper size, color or monochrome, and contents of the print data (e.g., text, low-resolution image, or high-resolution image). For example, the amount of toner of each color to be consumed can be obtained by referring to a table of statistical data based on a combination of parameters (e.g., A4, color, text). Any other method may also be used to calculate the amount of toner to be consumed. Thus, on the screen U103, the user can view estimated changes in the amounts of remaining toner and paper.

On a screen U104 illustrated in FIG. 9E, an image forming apparatus (B) in the middle is selected in addition to the closest image forming apparatus (A). On the screen U104, 5 pages are assigned to the image forming apparatus (A) and 95 pages are assigned to the image forming apparatus (B). The assignment or distribution of the number of pages to be printed may be determined according to an algorithm described later based on, for example, the ratio between the amounts of remaining paper of the image forming apparatuses (A) and (B). Also, the user can manually adjust the number of pages assigned to each of the image forming apparatuses (A) and (B) by touching the screen U104. When the number of pages assigned to an image forming apparatus is changed by the user, the additional information indicating the amounts of remaining toner and paper before and after printing is updated.

When a Print button is touched, a screen U105 of FIG. 9F is displayed. On the screen U105, a message indicating “Printing” and a status bar and numerals indicating the progress status of a print job are displayed as additional information for each of the image forming apparatuses (A) and (B).

When print jobs are completed at the image forming apparatuses (A) and (B), a screen U106 of FIG. 9G is displayed. When the user touches a “Confirm” button on the screen U106, the screen U102 (print reception screen) is displayed again.

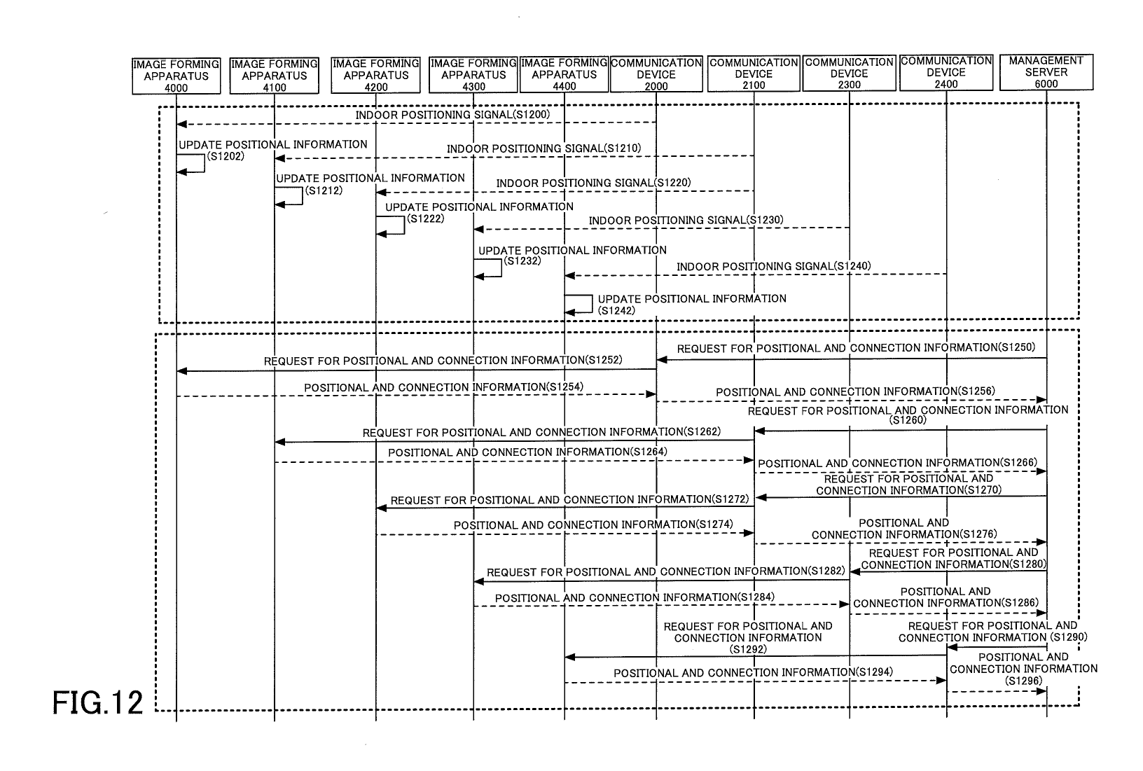

FIG. 12 is a sequence chart illustrating a process performed to exchange information among the communication devices 2000, 2100, 2300, and 2400, the image forming apparatuses 4000, 4100, 4200, 4300, and 4400, and the management server 6000. The exchange of information illustrated in FIG. 12 is common to the first through third embodiments. The process of FIG. 12 is performed at a predetermined interval to report positional information and connection information (e.g., IP address) of the image forming apparatuses 4000, 4100, 4200, 4300, and 4400 to the management server 6000. The interval to perform the process may be set freely by, for example, an administrator.

As illustrated in FIG. 12, the indoor positioning signal receiver 4017 of the image forming apparatus 4000 receives an indoor positioning signal (e.g., a positioning signal according to the IMES standard) transmitted from the indoor positioning signal transmitter 2002 of the communication apparatus 2000 (S1200). The image forming apparatus 4000 updates positional information stored in the storage unit 4011 with positional information newly obtained from the received indoor positioning signal (S1202). Similarly, the image forming apparatuses 4100, 4200, 4300, and 4400 receive indoor positioning signals from the corresponding communication devices 2100, 2300, and 2400, and update the positional information (S1210 through S1242).

Next, the communication unit 4012 of the image forming apparatus 4000 receives a request for positional information and connection information via, for example, a PAN and a LAN from the management server 6000 (S1250, S1252). For example, the request for positional information and connection information reaches the image forming apparatus 4000 via the gateway 5000 (see FIG. 8) and the communication device 2000. When receiving the request, the image forming apparatus 4000 transmits the positional information and the connection information (e.g., an IP address) stored in the storage unit 4011 via the PAN and the LAN to the management server 6000 (S1254, S1256). Similarly, each of the image forming apparatuses 4100 through 4400 receives a request for positional information and connection information from the management server 6000 and transmits the positional information and the connection information to the management server 6000 (S1260 through S1296).

Through the above process, the positional information and the connection information of all the image forming apparatuses 4000, 4100, 4200, 4300, and 4400 in the building are stored and managed in the management server 6000. Accordingly, the mobile terminal device 3000 can obtain the positional information and the connection information of the image forming apparatuses 4000, 4100, 4200, 4300, and 4400 from the management server 6000.

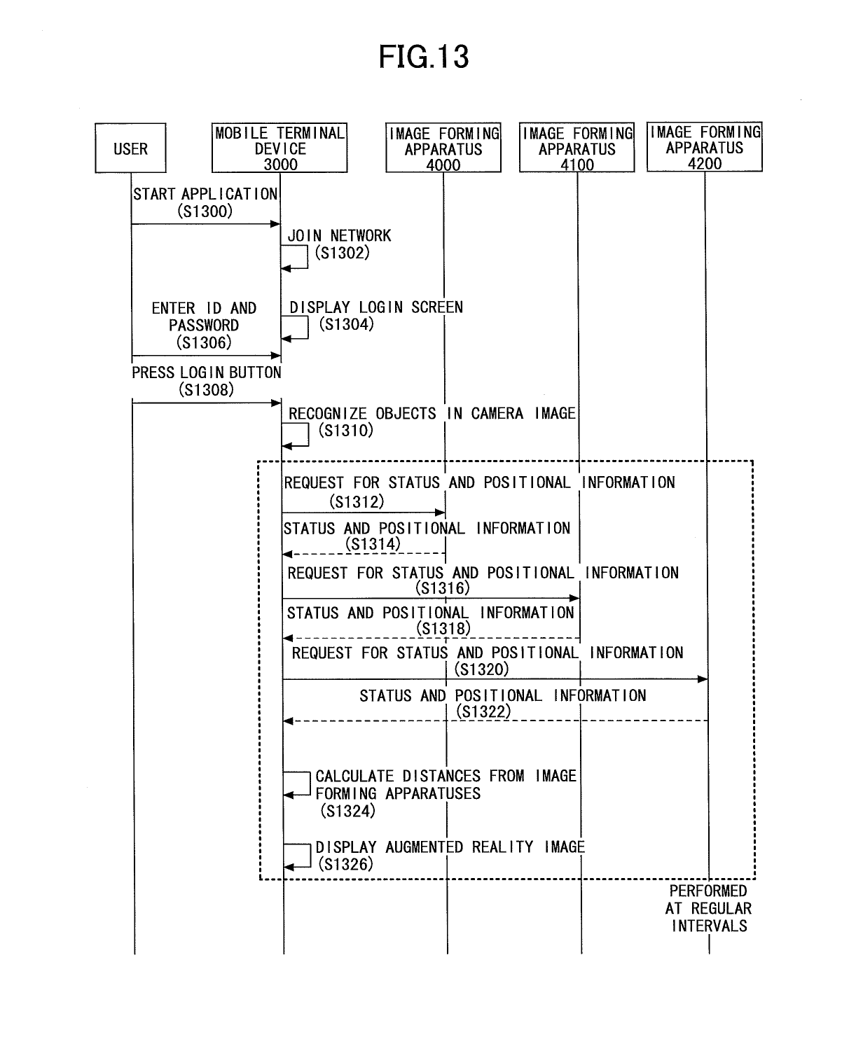

FIG. 13 is a sequence chart illustrating an exemplary process for displaying a print reception screen (or a print standby screen) according to the first and second embodiments.

First, the user of the mobile terminal device 3000 touches the icon of the application 9000 on the screen U100 of FIG. 9A to start the application 9000 (S1300).

Next, the communication unit 3012 of the mobile terminal device 3000 joins the PAN being managed by the gateway 5000 installed in the first floor in FIG. 8 (S1302) (here, it is assumed that the communication unit 3012 has not joined the PAN at the time when the application 9000 is started).

The device control unit 3010d of the mobile terminal device 3000 displays a login screen to request user authentication (S1304). When the image processing system 1000 is configured to not request user authentication, step S1304 may be omitted. In response, the user enters an ID and a password via the operations unit 3014 (S1306) and presses a login button (S1308).

The device control unit 3010d of the mobile terminal device 3000 activates a camera (i.e., the imaging unit 3017) to capture an image (camera image), and the AR image generating unit 3010c recognizes objects in the camera image (S1310). The camera image may be displayed on the display unit 3013.

The apparatus information obtaining unit 3010a of the mobile terminal device 3000 obtains status information and positional information from the image forming apparatuses 4000, 4100, and 4200 belonging to the same PAN (S1312 through S1322).

After obtaining the status information and the positional information, the AR image generating unit 3010c calculates the distances between the mobile terminal device 3000 and the image forming apparatuses 4000, 4100, and 4200 (S1324). The distances can be calculated, for example, based on the longitude and latitude coordinates of the mobile terminal device 3000 and the longitude and latitude coordinates of the image forming apparatuses 4000, 4100, and 4200, assuming that the Earth is a sphere.

The AR image generating unit 3010c superposes, on the camera image, additional information or augmented reality (AR) information including the status information obtained from the image forming apparatuses 4000, 4100, and 4200 to generate an augmented reality image, and displays the augmented reality image on the display unit 3013 (S1326). The AR image generating unit 3010c can display the additional information of the image forming apparatuses 4000, 4100, and 4200 such that the size of the displayed additional information becomes greater as the distance from the mobile terminal device 3000 decreases and becomes smaller as the distance from the mobile terminal device 300 increases (see, for example, the screen U102 of FIG. 9C). In other words, the AR image generating unit 3010c can display additional information of image forming apparatuses at different distances in perspective.

Steps S1312 through S1326 for obtaining the status information and the positional information and displaying the augmented reality image are preferably performed at regular intervals in the background because the status information and the positional information may change from time to time.

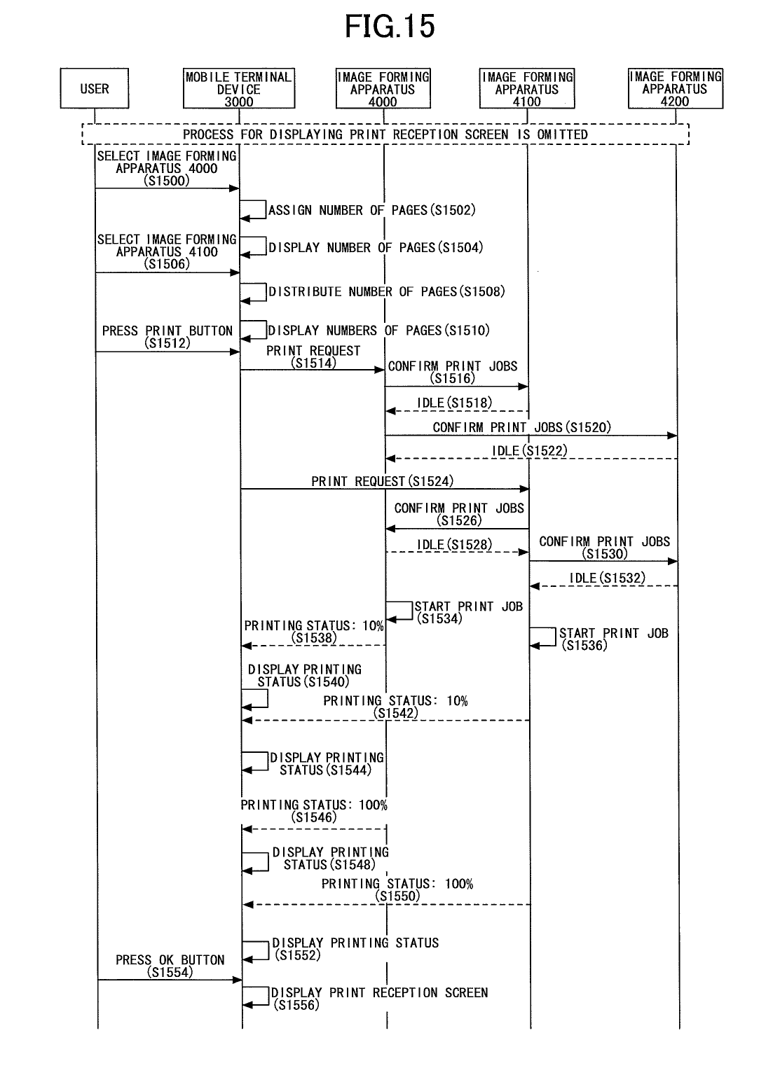

FIG. 15 is a sequence chart illustrating an exemplary printing process according to the first embodiment.

When the screen U102 of FIG. 9C is displayed on the display unit 3013 of the mobile terminal device 3000, the user selects the image forming apparatus 4000 via the operations unit 3014 (S1500). The distribution unit 3010b of the mobile terminal device 3000 assigns the entire number of pages to be printed by the user to the selected image forming apparatus 4000 (S1502) (see, for example, the screen U103 of FIG. 9D). Also, the AR image generating unit 3010c highlights the image forming apparatus 4000 to indicate that the image forming apparatus 4000 is selected, and displays the assigned number of pages as additional information superposed on the camera image (S1504) (see, for example, the screen U103 of FIG. 9D). Next, when the user further selects the image forming apparatus 4100 (S1506), the distribution unit 3010b distributes the number of pages to be printed by the user among the selected image forming apparatuses 4000 and 4100 (S1508). Hereafter, the distribution results may be referred to as “distributed numbers of pages”. The distribution of the number of pages may be determined, for example, based on the status information obtained from the image forming apparatuses 4000 and 4100 to keep the balance of the amounts of remaining toner and paper of the image forming apparatuses 4000 and 4100. An exemplary algorithm for calculating the distribution is described later. Then, the AR image generating unit 3010c displays the distributed numbers of pages as additional information superposed on the camera image (S1510) (see, for example, the screen U104 of FIG. 9E).

When the user presses the Print button on the screen U104 of FIG. 9E (S1512), the distribution unit 3010c transmits print requests requesting to execute print jobs to the selected image forming apparatuses 4000 and 4100 according to the distributed numbers of pages (S1514, S1524).

Each of the image forming apparatuses 4000 and 4100 receiving the print request confirms print jobs received or being executed at other image forming apparatuses to determine whether other print jobs have been entered after (or at the same time as) receiving the print request and thereby determine whether it is necessary to redistribute the number of pages (S1516 through S1522, S1526 through S1532). In the example of FIG. 15, it is assumed that none of the image forming apparatuses 4000, 4100, and 4200 has received any other print job from, for example, another mobile terminal device, i.e., all the image forming apparatuses 4000, 4100, and 4200 are idle (or ready), and redistribution of the number of pages is not necessary.

The image forming apparatuses 4000 and 4100 starts the print jobs (S1534, S1536). During the print job, the apparatus and status information management unit 4010c of each of the image forming apparatuses 4000 and 4100 reports printing status to the mobile terminal device 3000 at predetermined or regular intervals (S1538, S1542). When receiving the printing status, the AR image generating unit 3010c of the mobile terminal 3000 displays the printing status as additional information superposed on the camera image (S1540, S1544) (see, for example, the screen U105 of FIG. 9F). When printing status indicating the completion of the print job (i.e., printing status is 100%) is received from each of the image forming apparatuses 4000 and 4100 (S1546, S1550), the AR image generating unit 3010c also displays the printing status as additional information superposed on the camera image (S1548, S1552).

When the print jobs at both of the image forming apparatuses 4000 and 4100 are completed, a message indicating the completion of the printing process is displayed on the mobile terminal device 3000 together with an OK (confirmation) button (see, for example, the screen U106 of FIG. 9G). Then, the user presses the OK button via the operations unit 3014 (S1554). As a result, the print reception screen is displayed again on the display unit 3013 of the mobile terminal device 3000 (S1556).

As described above, with the image processing system 1000 of the present embodiment, it is possible to properly distribute the number of pages to be printed among image forming apparatuses based on the amounts of remaining toner and paper of the image forming apparatuses. This in turn makes it possible to prevent a situation where only a particular one of image forming apparatuses runs out of toner and/or paper.

### 4. Second Embodiment

Next, the second embodiment is described. In the second embodiment, it is assumed that print jobs are issued concurrently from mobile terminal devices of multiple users. As in the first embodiment, the configuration of the image processing system 1000 illustrated by FIG. 8 is used in the second embodiment.

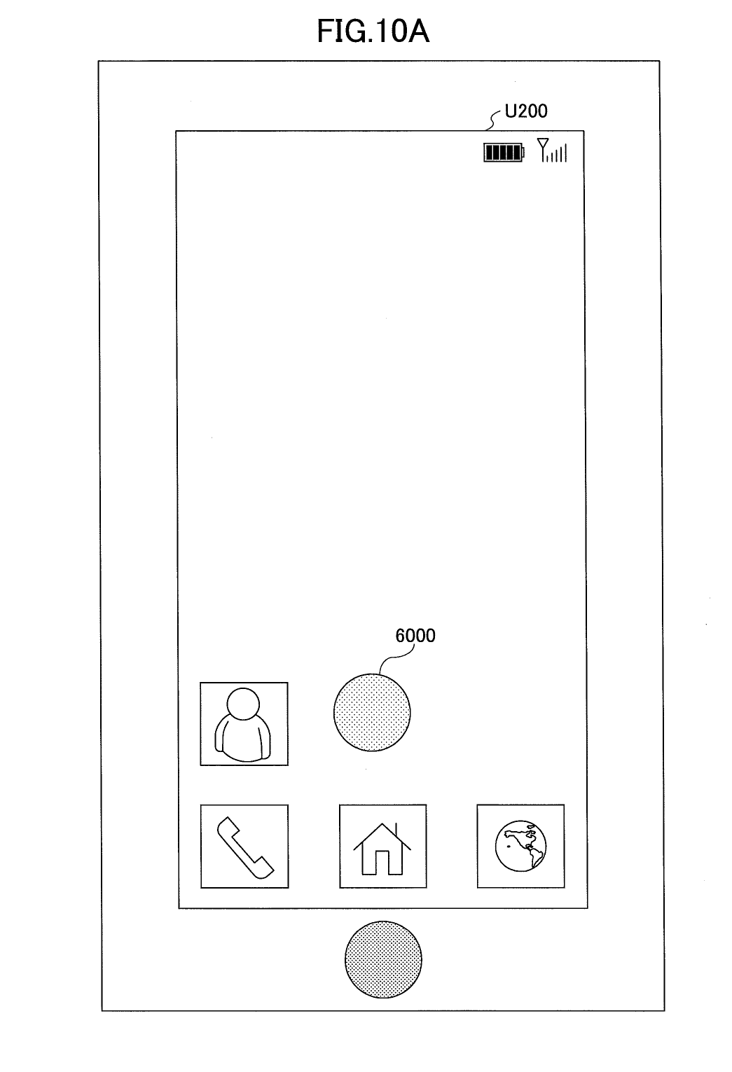

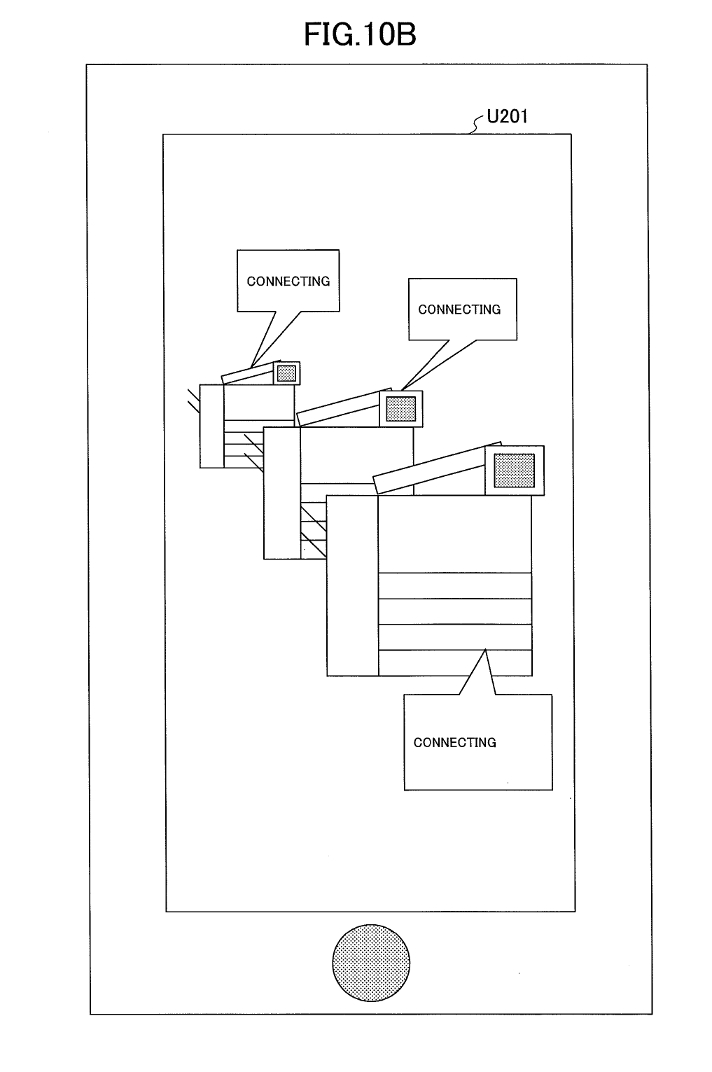

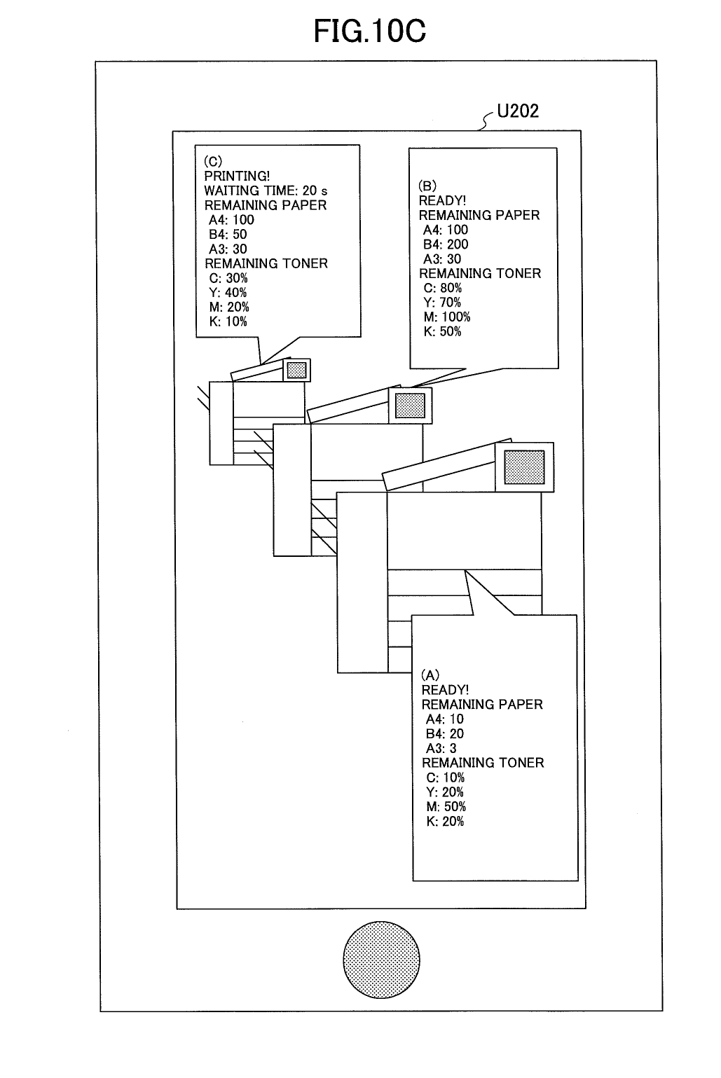

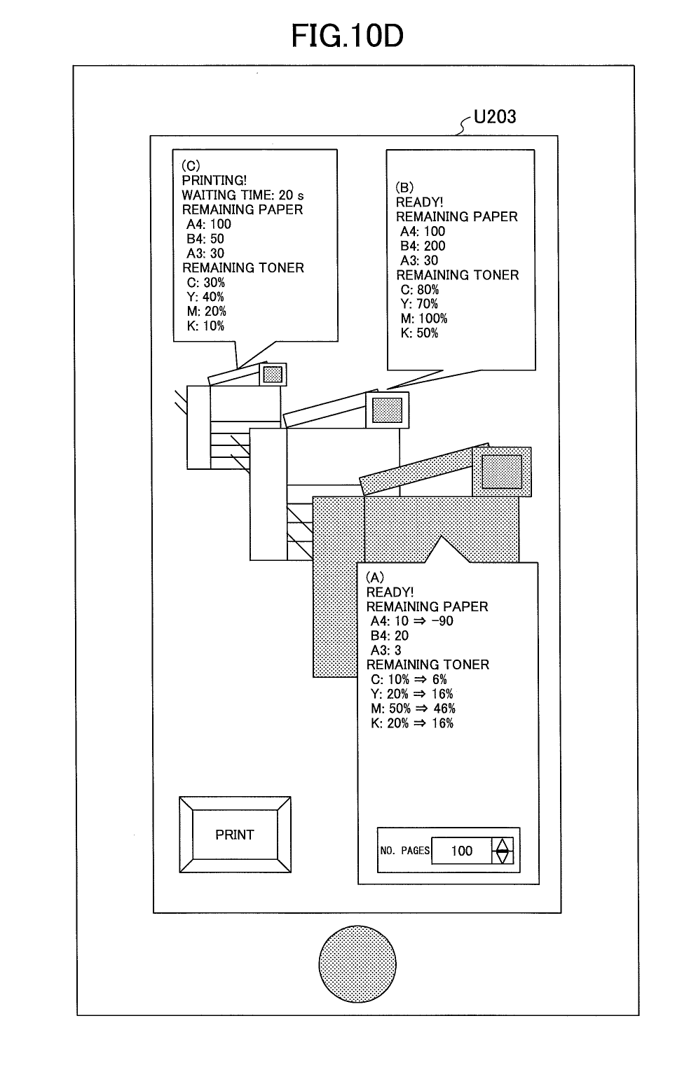

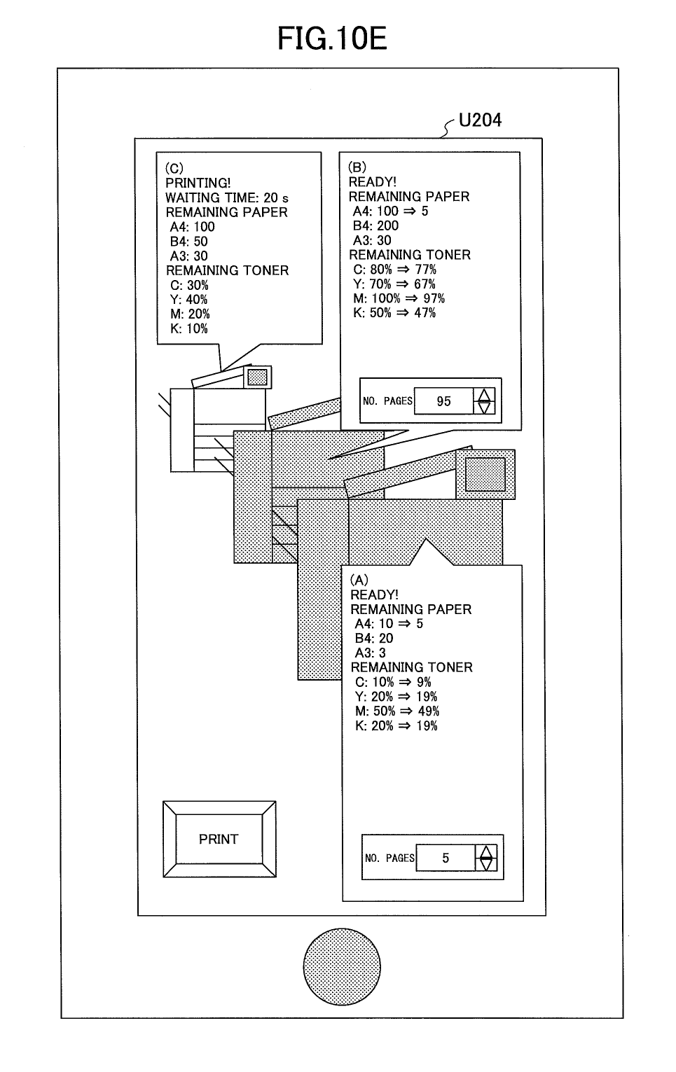

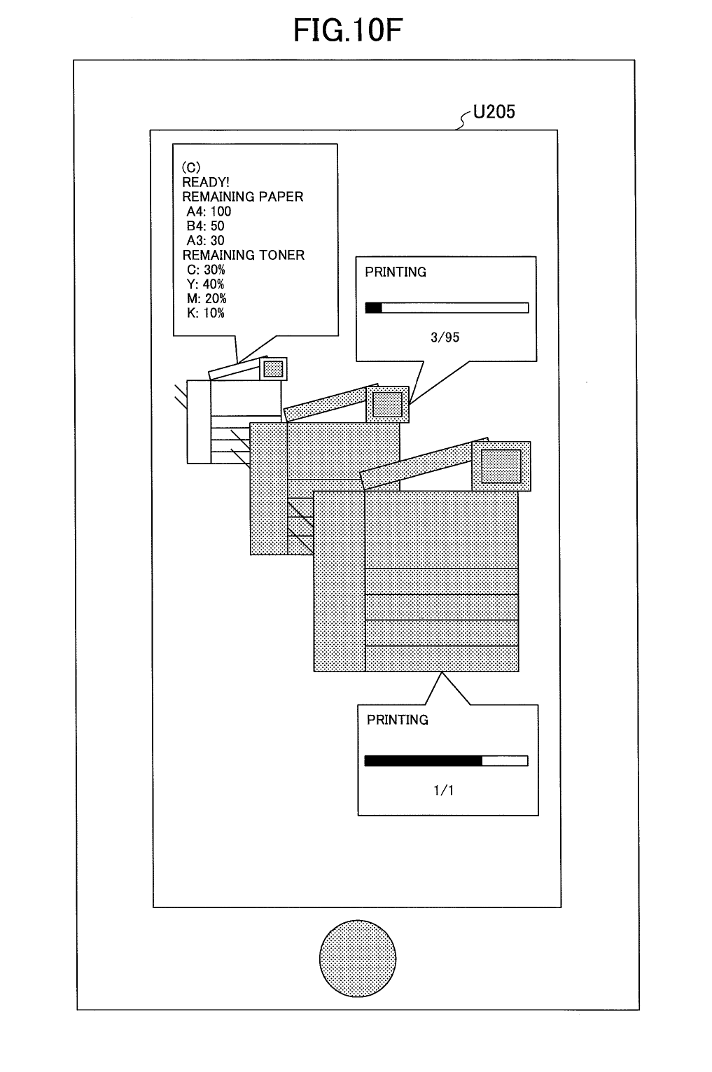

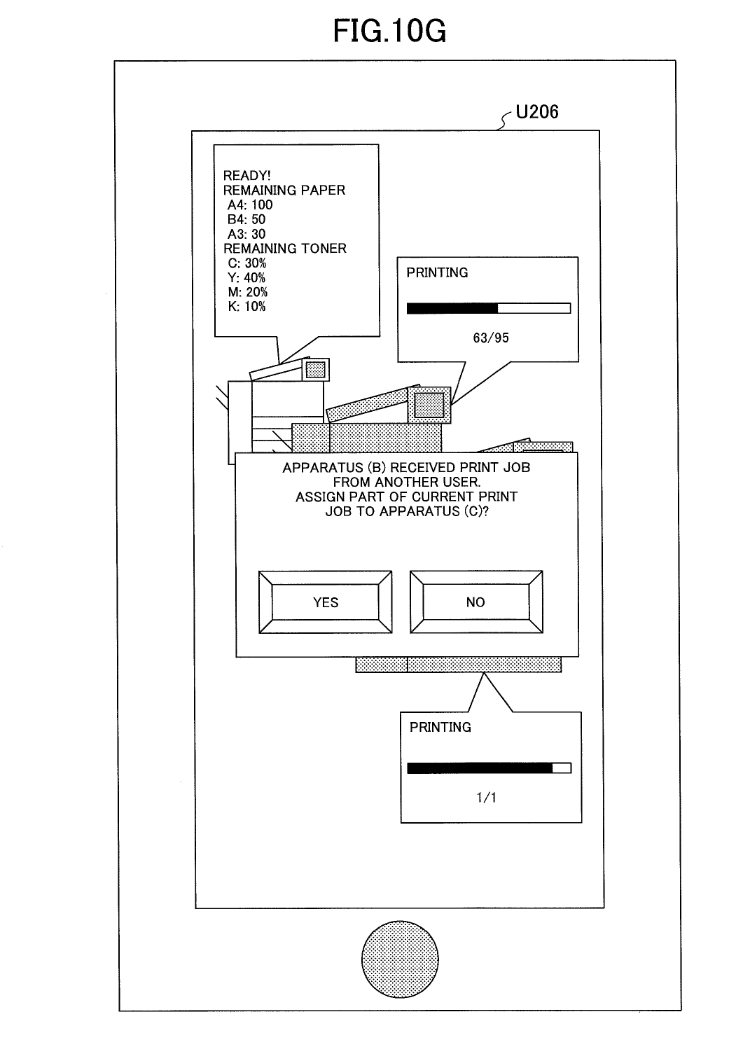

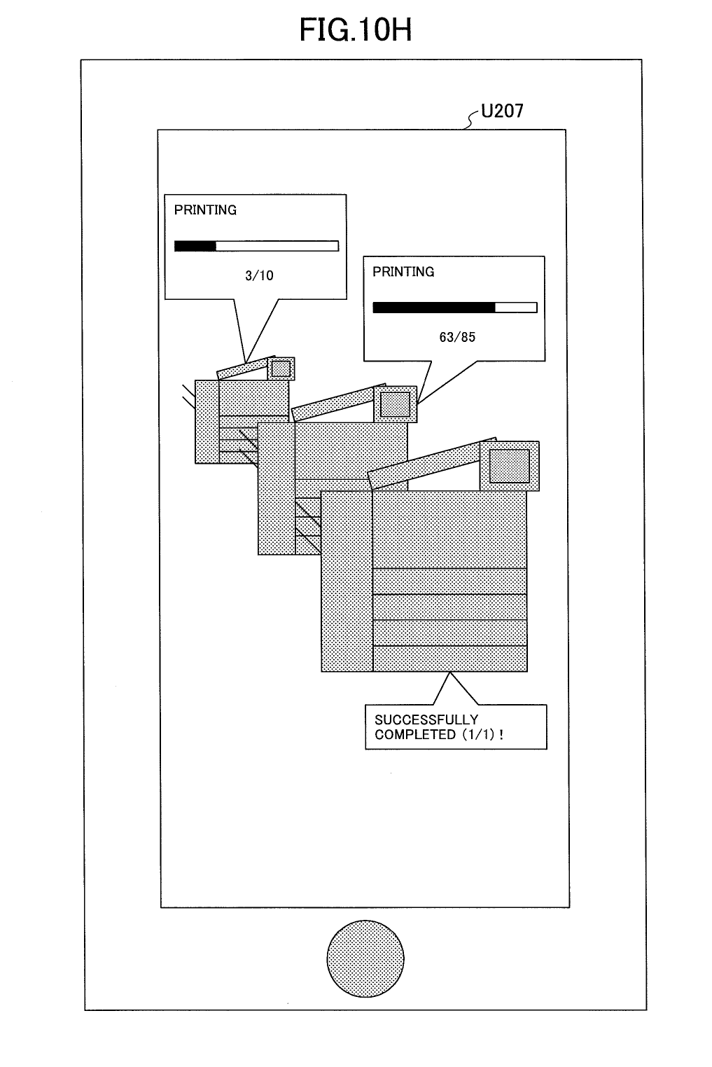

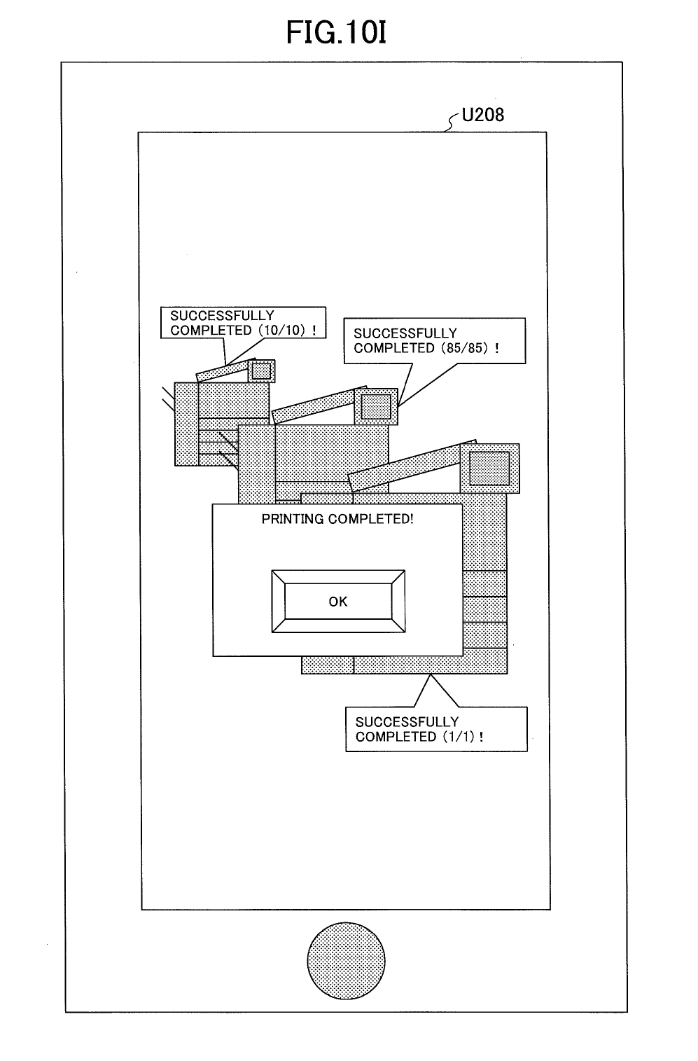

FIGS. 10A through 10I are drawings illustrating exemplary augmented reality images displayed on the mobile terminal device 3000 according to the second embodiment.

Screens U200 through U205 of FIGS. 10A through 10F are substantially the same as the screens U100 through U105 of FIGS. 9A through 9F used in the first embodiment.

When the image forming apparatus (B) in the middle, which is executing a print job requested by a user, receives another print job from a mobile terminal device of another user, a screen U206 of FIG. 10G is displayed. Because another print job is received by the image forming apparatus (B), the amounts of remaining toner and paper of the image forming apparatuses (A) through (C) after printing may be unbalanced. The screen U206 is used to request the user to determine whether to redistribute the number of pages assigned to the image forming apparatus (B). When the user presses a Yes button, a screen U207 of FIG. 10H is displayed. On the other hand, when the user presses a No button, the print job is continued at the image forming apparatus (B), and a screen that is the same as the screen U106 of FIG. 9G is displayed.

When the user presses the Yes button, the number of pages assigned to the image forming apparatus (B) is redistributed to and printed on the image forming apparatuses (B) and (C) as displayed on the screen U207.

When print jobs are completed at the image forming apparatuses (A) through (C), a screen U208 of FIG. 10I is displayed. When the user touches an OK (confirmation) button on the screen U208, the screen U202 is displayed again.

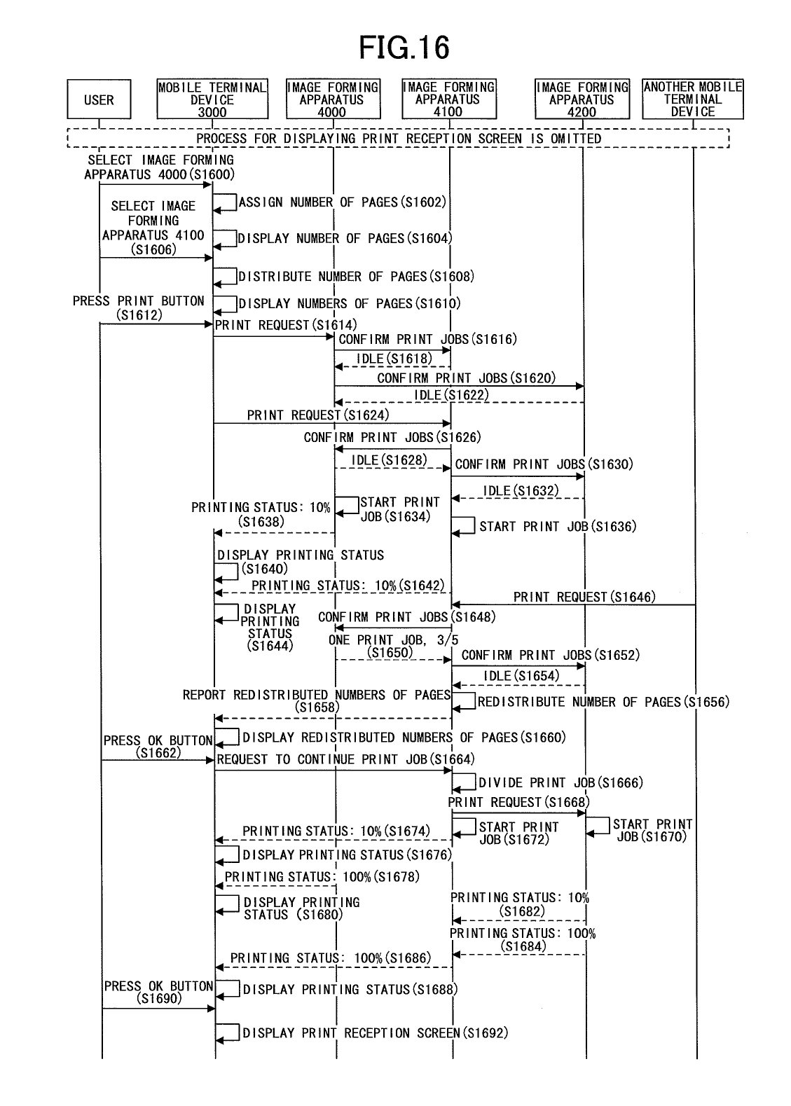

FIG. 16 is a sequence chart illustrating an exemplary printing process according to the second embodiment. In the second embodiment, similarly to the first embodiment, it is assumed that the image forming apparatuses 4000, 4100, 4200, 4300, and 4400 obtain positional information and transmit the positional information together with connection information to the management server 6000 as described above with reference to FIG. 12. Also in the second embodiment, it is assumed that the mobile terminal device 3000 displays a print reception screen through the process described above with reference to FIG. 13. Below, steps of FIG. 16 that are different from the steps of FIG. 15 are mainly described.

Steps S1600 through S1644 of FIG. 16 are substantially the same as steps S1500 through S1544 of FIG. 15 described in the first embodiment.

After step S1644, a print request is transmitted from a mobile terminal device (or any terminal) of another user to the image forming apparatus 4100 (S1646). In response, the distribution unit 4010d of the image forming apparatus 4100 confirms the status of print jobs being executed at the image forming apparatuses 4000 and 4200 belonging to the same PAN (S1648, S1652). In this example, the image forming apparatus 4000 transmits, to the image forming apparatus 4100, status information indicating that one print job is being executed and three out of five pages (3/5) in the print job have already been completed (S1650). On the other hand, the image forming apparatus 4200 transmits, to the image forming apparatus 4100, status information indicating that no print job is being executed and the image forming apparatus 4200 is idle (or ready) (S1654). Based on the status information received from the image forming apparatuses 4000 and 4200, the distribution unit 4010d of the image forming apparatus 4100 redistributes the number of pages in a print job assigned to the image forming apparatus 4100 such that the amounts of remaining toner and paper of the image forming apparatuses 4000, 4100, and 4200 are balanced (S1656). Hereafter, the redistribution results are referred to as “redistributed numbers of pages”. An exemplary algorithm for determining the distribution is described later. The image forming apparatus 4100 reports the redistributed numbers of pages to the mobile terminal device 3000 (S1658). In response, the device control unit 3010d of the mobile terminal device 3000 displays the redistributed numbers of pages on the display unit 3013 (S1660), and requests the user to determine whether to perform a printing process according to the redistribution results (see, for example, the screen U206 of FIG. 10G). When the user presses an OK button via the operations unit 3014 (S1662), the device control unit 3010d of the mobile terminal device 3000 requests the image forming apparatus 4100 to continue the print job according to the redistributed numbers of pages (S1664).

When receiving the request, the distribution unit 4010d of the image forming apparatus 4100 divides the print job assigned to itself according to the redistributed numbers of pages determined at step S1656 (S1666). In this example, it is assumed that a portion of the number of pages initially assigned to the image forming apparatus 4100 is assigned to the image forming apparatus 4200 according to the redistributed numbers of pages. The image forming apparatus 4100 transmits a portion of the divided print job as a print request to the image forming apparatus 4200 (S1668), In response to the print request, the image forming apparatus 4200 starts the portion of the print job (S1670). Also, the image forming apparatus 4100 starts another portion of the print job (S1672). During the print job, each of the image forming apparatuses 4000, 4100, and 4200 reports printing status to the mobile terminal device 3000 at predetermined or regular intervals (S1674, S1678). The image forming apparatus 4200 executing a portion of the print job assigned by the image forming apparatus 4100 may report printing status to the image forming apparatus 4100 (S1682, S1684), In this case, the image forming apparatus 4100 combines the printing status of the portion of the print job being executed by itself and the printing status reported from the image forming apparatus 4200, and transmits the combined printing status to the mobile terminal device 3000 (S1686). The mobile terminal device 3000 displays the printing status received from the image forming apparatuses 4000, 4100, and 4200 as additional information on a screen (S1676, S1680, S1688) (see, for example, the screen U207 of FIG. 10H). When all print jobs are completed (when the printing statuses from all image forming apparatuses indicate 100%), the mobile terminal device 3000 displays a message indicating the completion of the printing process and a dialog box requesting the user to confirm the message (see, for example, the screen U208 of FIG. 10I). When an OK button is pressed by the user on the dialog box (S1690), the mobile terminal device 3000 displays the print reception screen again (S1692).

In the exemplary process described above, the number of pages in a print job is redistributed taking into account the status of image forming apparatuses belonging to the same PAN. However, the present invention is not limited to this example. As another example, an image forming apparatus receiving an additional print request may redistribute the number of pages among image forming apparatuses initially selected by the user. As still another example, an image forming apparatus receiving an additional print request may obtain information also from image forming apparatuses in other floors in a building and redistribute the number of pages among image forming apparatuses including those in the other floors.

Thus, according to the second embodiment, when an image forming apparatus executing a current print job requested by a mobile terminal device receives an additional print job from another mobile terminal device, the image forming apparatus can redistribute the number of pages to be printed in the current print job taking into account the number of pages to be printed in the additional print job such that the amounts of remaining toner and paper of multiple image forming apparatuses are balanced, and can continue the current print job according to the redistribution results.

### 5. Third Embodiment

Next, the third embodiment is described. According to the third embodiment, it is possible to distribute the number of pages to be printed among image forming apparatuses including those not in a camera image taken by a mobile terminal device. As in the first and second embodiments, the configuration of the image processing system 1000 illustrated by FIG. 8 is used in the third embodiment.

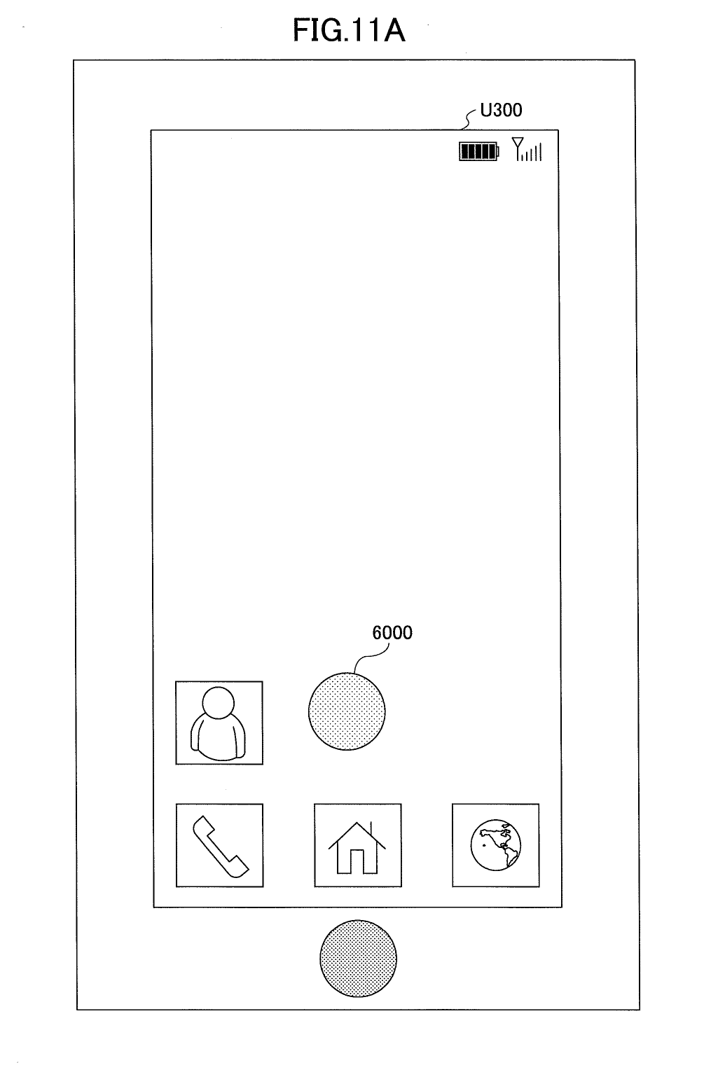

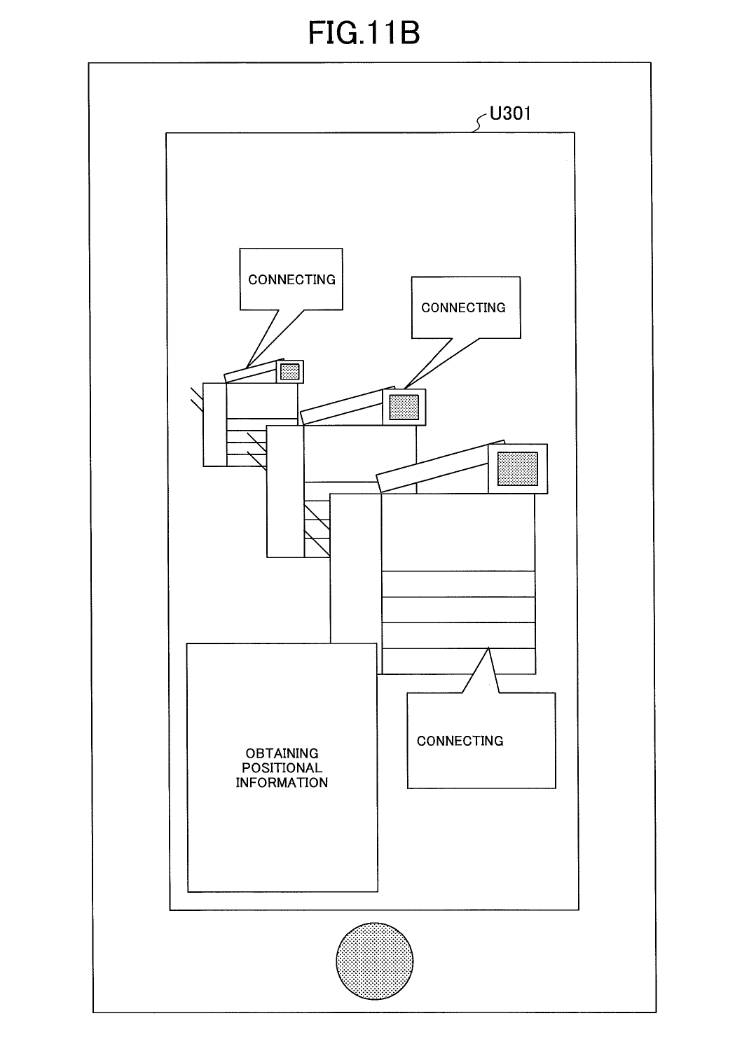

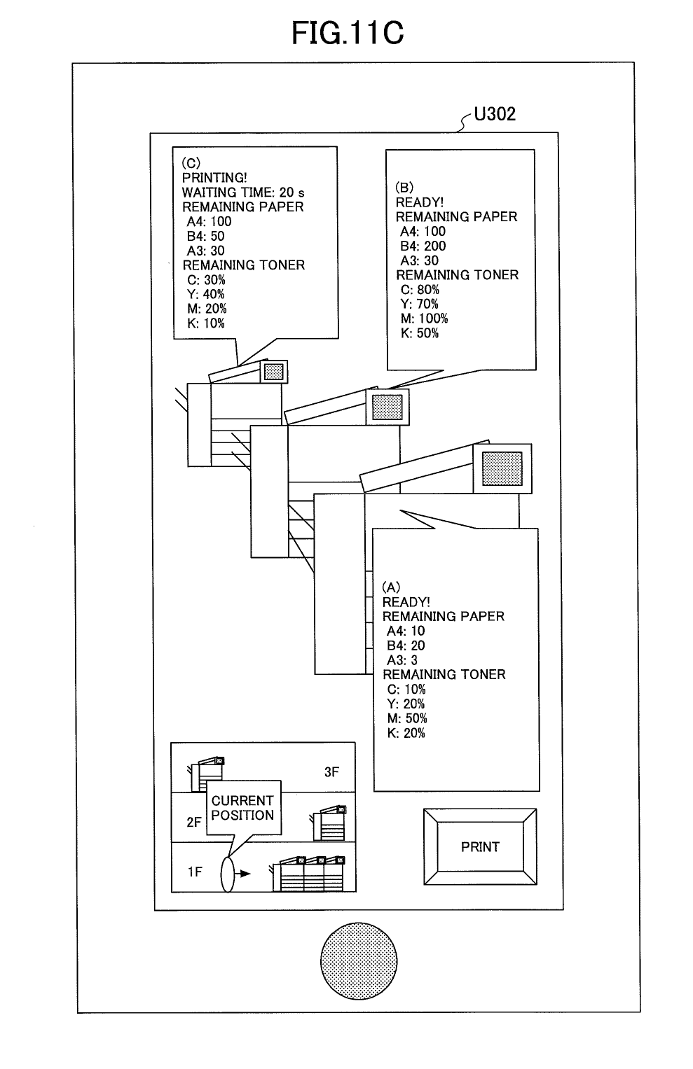

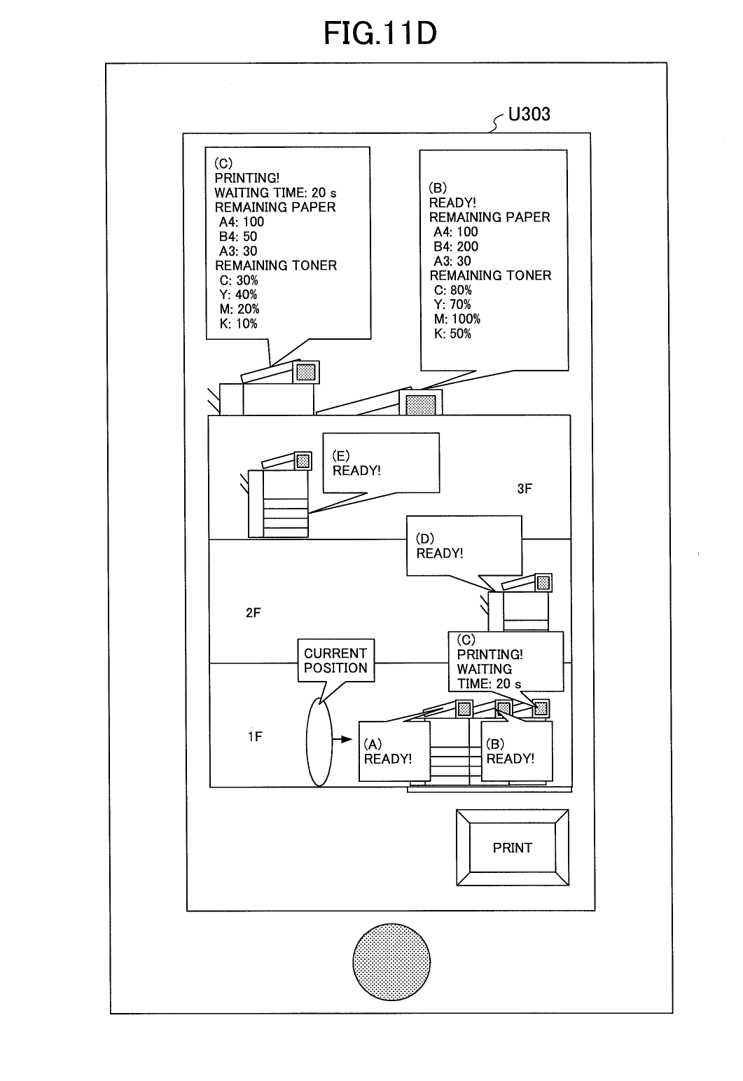

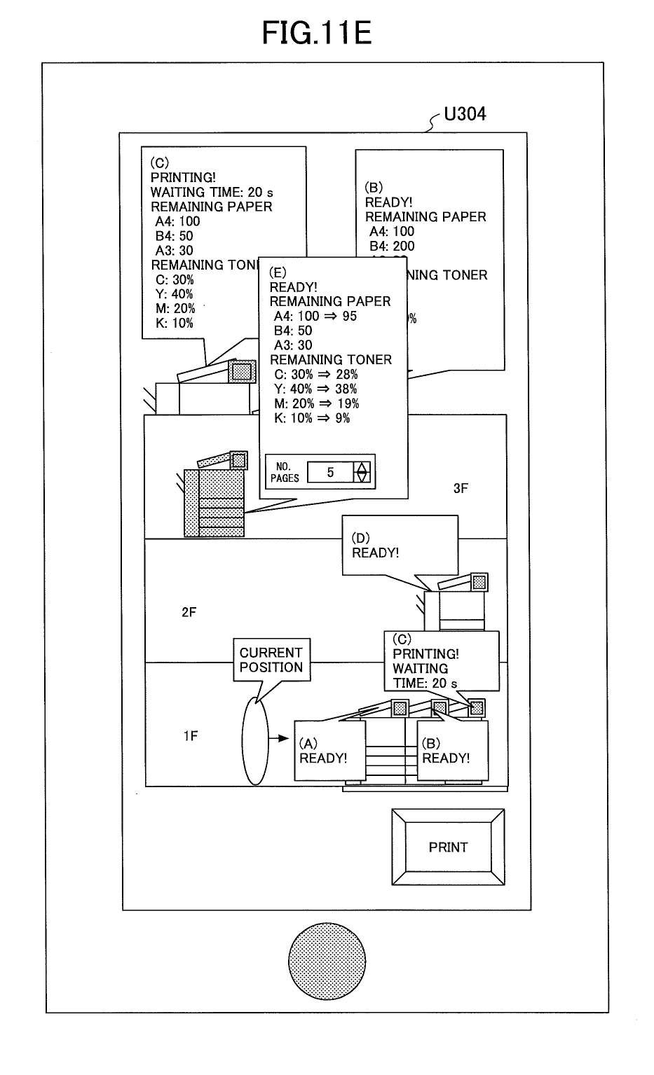

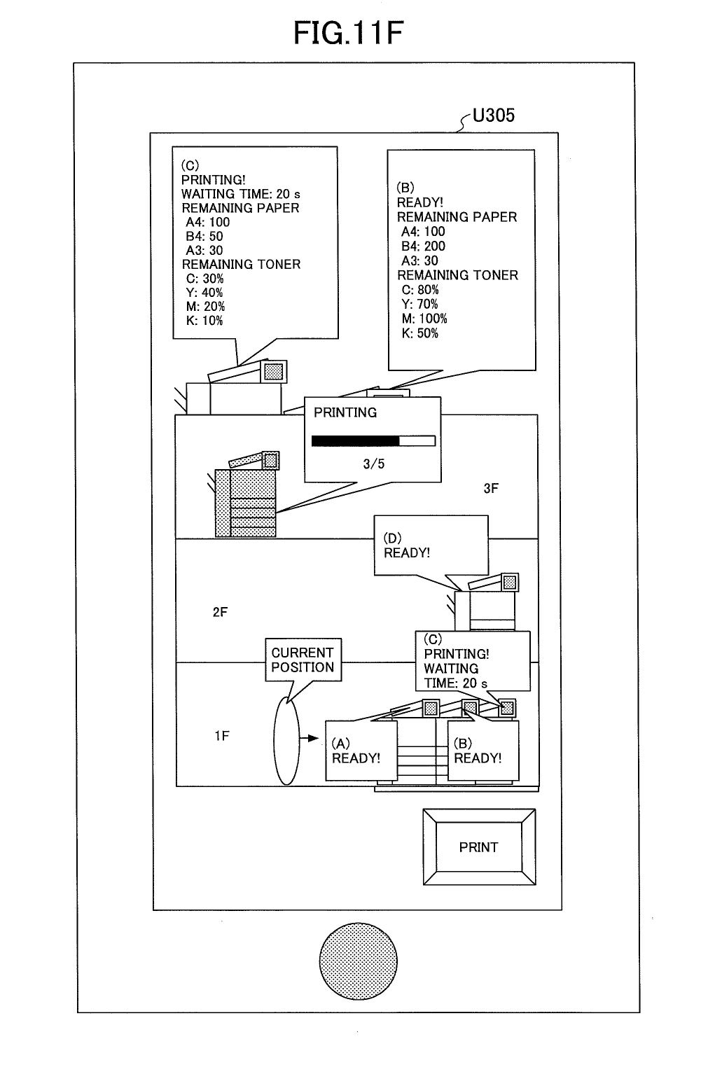

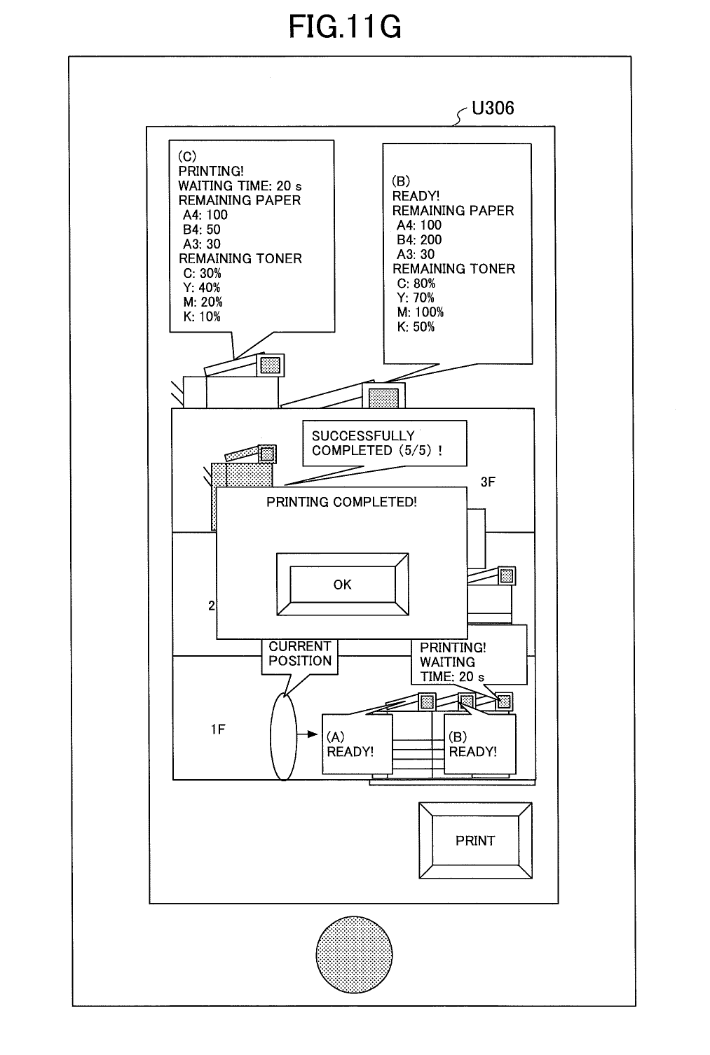

FIGS. 11A through 11G are drawings illustrating exemplary augmented reality images displayed on the mobile terminal device 3000 according to the third embodiment.

A screen U300 of FIG. 11A is the same as the screen U100 of FIG. 9A.

A screen U301 of FIG. 11B is similar to the screen U101 of FIG. 9B except that the screen U301 also includes a message indicating that positional information and connection information of image forming apparatuses (e.g., image forming apparatuses in other floors of a building) not included in a camera image are also being obtained from the management server 6000.

A screen U302 of FIG. 11C is similar to the screen U102 of FIG. 9C except that the screen U302 also includes a floor map of the building. The floor map may be displayed by the AR image generating unit 3010c. Information representing the floor map may be stored beforehand in the mobile terminal device 3000 or obtained from an external server such as the management server 6000. With the floor map, the user can identify its current position as well as the positions of image forming apparatuses installed in the building.

When the user touches the floor map, a screen U303 of FIG. 11D is displayed. As illustrated by FIG. 11D, the floor map is displayed with an enlarged size in substantially the center of the screen U303. With the screen U303, the user can more accurately identify the positions of image forming apparatuses in the building.

In a screen U304 of FIG. 11E, it is assumed that the user has selected an image forming apparatus (E) in the third floor and has set the number of pages to be printed at 5.

When the user presses a Print button on the screen U304, a screen U305 of FIG. 11F is displayed. On the screen U305, the status of a print job being executed by the image forming apparatus (E) is displayed.

When the print job is completed at the image forming apparatus (E), a screen U306 of FIG. 11G is displayed. When the user touches an OK (confirmation) button on the screen U306, the screen U303 is displayed again.

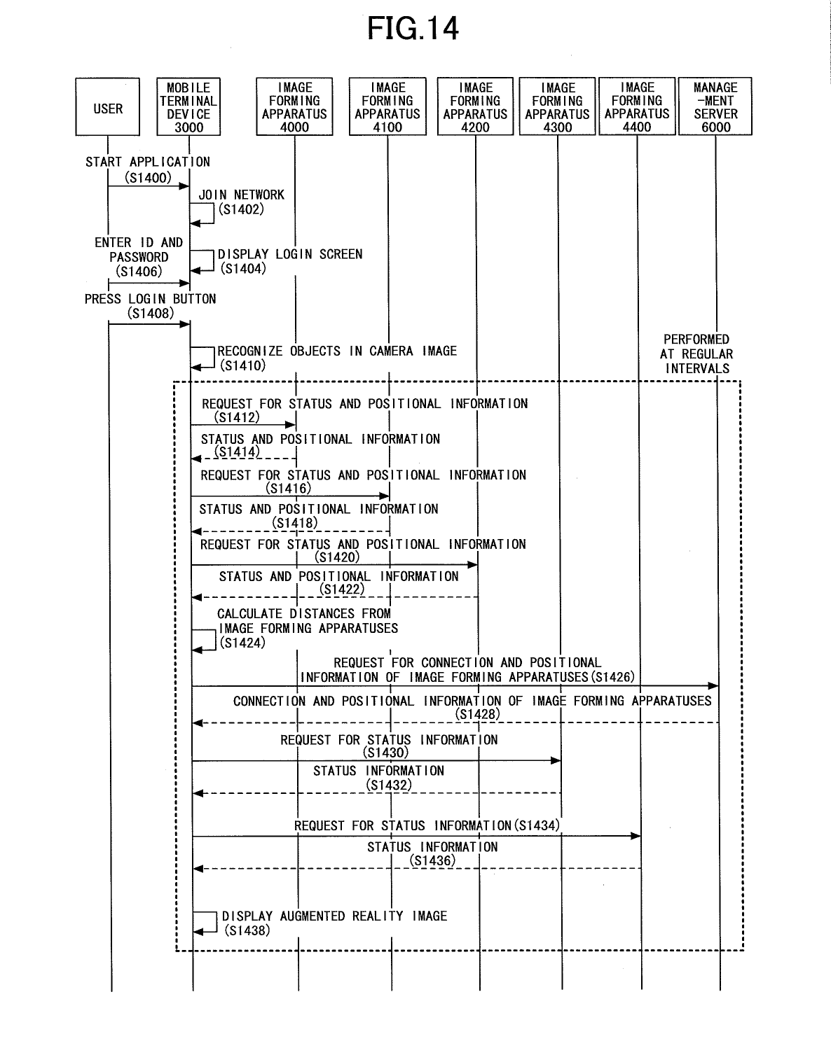

FIG. 14 is a sequence chart illustrating an exemplary process for displaying a print reception screen (or a print standby screen) according to the third embodiment. Also in the third embodiment, it is assumed that the image forming apparatuses 4000, 4100, 4200, 4300, and 4400 obtain positional information and transmit the positional information together with connection information to the management server 6000 as described above with reference to FIG. 12.

Steps S1400 through S1424 of FIG. 14 are substantially the same as steps S1300 through S1324 of FIG. 13 described in the first embodiment.

The apparatus information obtaining unit 3010a of the mobile terminal device 3000 requests and obtains connection information and positional information of the image forming apparatuses 4300 and 4400 on the second and third floors from the management server 6000 (S1426, S1428). Next, the apparatus information obtaining unit 3010a of the mobile terminal device 3000 obtains status information from the image forming apparatuses 4300 and 4400 using the obtained connection information (S1430 through S1436). When the connection information indicates an IP address, the apparatus information obtaining unit 3010a can obtain status information from each of the image forming apparatuses 4300 and 4400 via, for example, a wireless LAN or a 3G mobile network. The AR image generating unit 3010c superposes, on a camera image, additional information or augmented reality (AR) information including the status information obtained from the image forming apparatuses 4000 through 4400 to generate an augmented reality image, and displays the augmented reality image on the display unit 3013 (S1438).

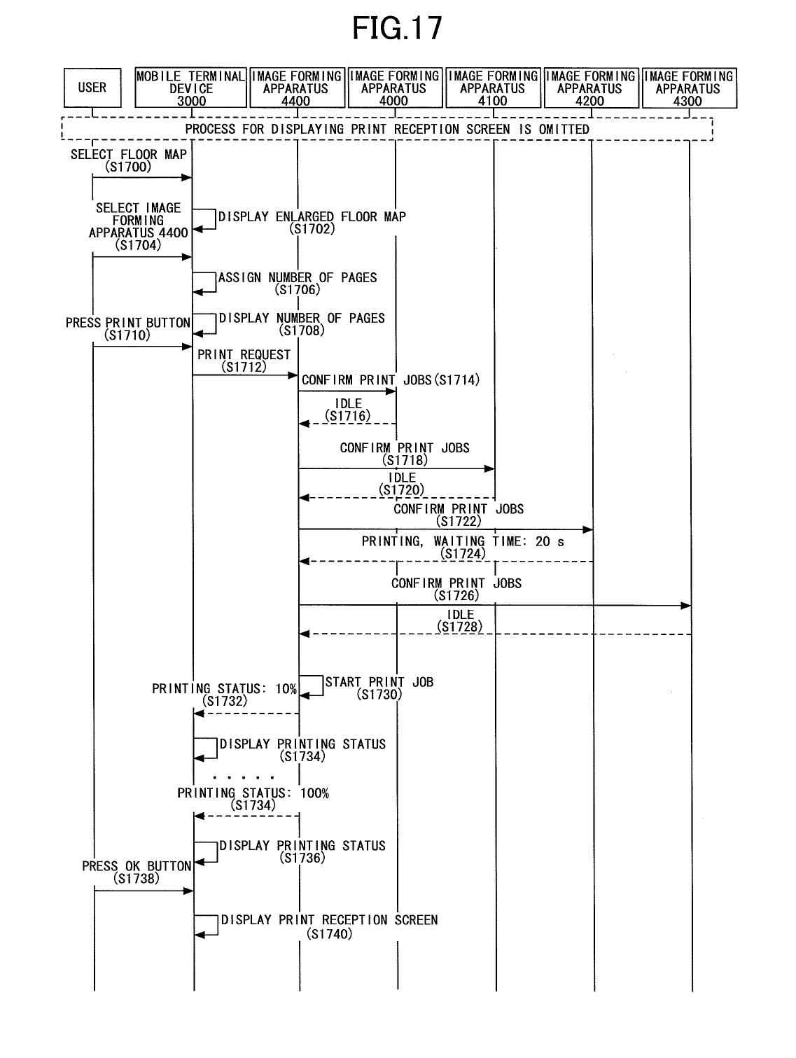

FIG. 17 is a sequence chart illustrating an exemplary printing process according to the third embodiment.

First, the user selects, via the operations unit 3014, the floor map displayed on the screen U302 of FIG. 11C (S1700). In response, the AR image generating unit 3010c of the mobile terminal device 3000 displays the floor map with an enlarged size on the display unit 3013 (S1702) (see, for example, the screen U303 of FIG. 11D). When the user selects the image forming apparatus 4400 on the floor map (S1704), the number of pages assigned to the image forming apparatus 4400 is displayed on the screen U304 through steps S1706 and S1708 that are similar to steps S1508 and S1510 of FIG. 15. When the user presses the Print button (S1710), the distribution unit 3010b transmits a print request requesting to execute a print job to the selected image forming apparatus 4400 (S1712). When receiving the print request, the image forming apparatus 4400 confirms print jobs received or being executed at the image forming apparatuses 4000-4300 through steps S1714-S1728 that are similar to steps S1516-S1522 of FIG. 15. In the example of FIG. 17, it is assumed that none of the image forming apparatuses 4000 through 4300 has received any other print job from, for example, another mobile terminal device, and redistribution of the number of pages is not necessary.

The image forming apparatus 4400 starts a print job (S1730). Then, printing status is displayed and when the print job is completed and the OK button is pressed, the print reception screen is displayed again through steps S1732-S1740 that are similar to steps S1538-S1556 of FIG. 15.

In the exemplary process described above, only the image forming apparatus 4400 is selected to execute a print job. However, also in the third embodiment, multiple image forming apparatuses may be selected to execute print jobs as described in the first and second embodiments with reference to FIGS. 15 and 16. In this case, the number of pages to be printed is distributed among the selected image forming apparatuses such that the amounts of remaining toner and paper of the selected image forming apparatuses are balanced after printing. Also in the third embodiment, when an image forming apparatus executing a current print job requested by a mobile terminal device receives an additional print job from another mobile terminal device, the image forming apparatus can temporarily stop the execution of the current print job to redistribute the number of pages to be printed in the current print job and continue the current print job according to the redistribution results.

As described above, with the image processing system 1000 of the third embodiment, it is possible to request even an image forming apparatus not included in a camera image to execute a print job. Also, the third embodiment makes it possible to distribute the number of pages to be printed among image forming apparatuses in a building including those not present in a camera image such that the amounts of remaining toner and paper of the image forming apparatuses are balanced. This in turn makes it possible to prevent a situation where only a particular one of image forming apparatuses in a building runs out of toner and/or paper.

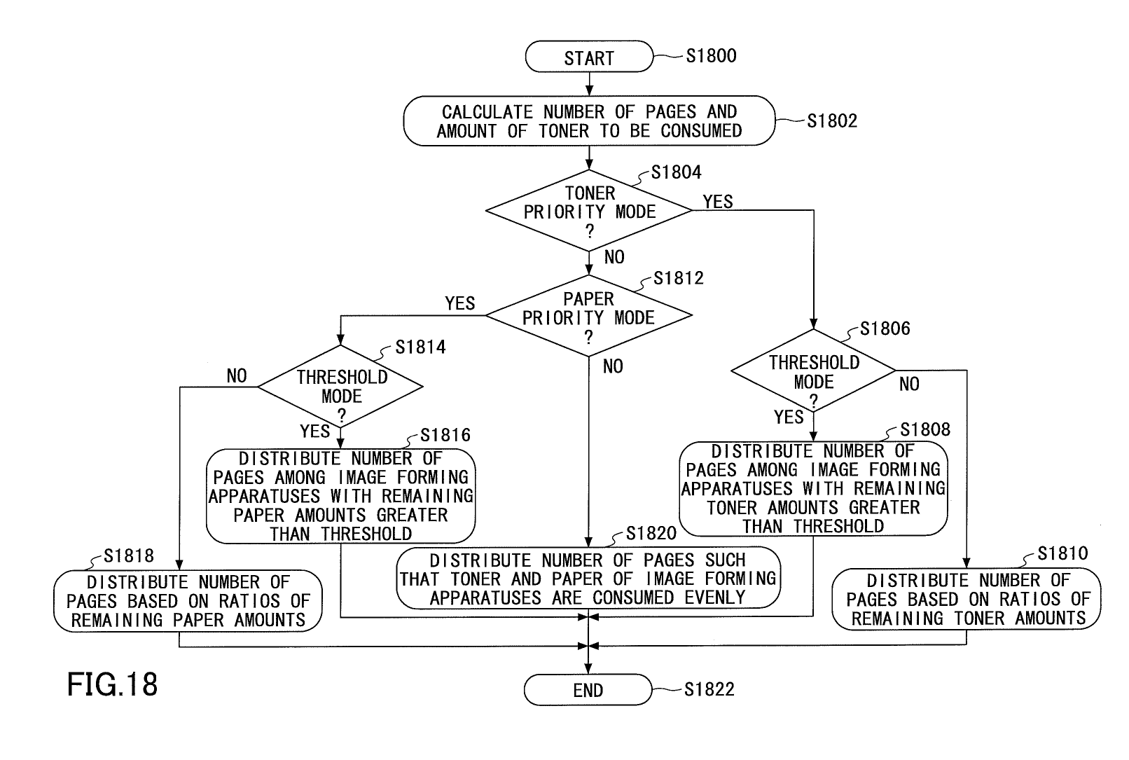

An exemplary algorithm for determining how to distribute the number of pages to be printed among image forming apparatuses is described below with reference to FIG. 18. The process of FIG. 18 is performed by either one of the distribution unit 3010c of the mobile terminal device 3000 (or 3100) and the distribution unit 4010d of the image forming apparatus 4000 (4100, 4200, 4300, or 4400). In the descriptions below, the distribution unit 3010c or the distribution unit 4010d is simply referred to as a “distribution unit”.

At step S1800, the process is started.

At step S1802, the distribution unit calculates the number of pages to be printed and the amount of toner to be consumed based on the details of a print job to be executed by a user. The amount of toner to be consumed can be calculated based on parameters such as a paper size, color or monochrome, and contents of the print data (e.g., text, low-resolution image, or high-resolution image). The amount of toner to be consumed can be calculated according to any known method. For example, the amount of toner of each color to be consumed can be obtained by referring to a table of statistical data based on a combination of parameters (e.g., A4, color, text). The amount of toner to be consumed can be represented by any measurement unit such as a percentage with respect to the full capacity or grams.

The distribution unit operates in one of the following predetermined modes:
Toner priority mode (non-threshold mode) where the number of pages is distributed based on the ratios of the amounts of remaining toner.
Toner priority mode (threshold mode) where the number of pages is distributed among image forming apparatuses whose amounts of remaining toner are greater than a threshold (or image forming apparatuses other than image forming apparatuses whose amounts of remaining toner are less than or equal to a threshold).
Paper priority mode (non-threshold mode) where the number of pages is distributed based on the ratios of the amounts of remaining paper.
Paper priority mode (threshold mode) where the number of pages is distributed among image forming apparatuses whose amounts of remaining paper are greater than a threshold (or image forming apparatuses other than image forming apparatuses whose amounts of remaining paper are less than or equal to a threshold)
Balanced mode where the number of pages is distributed such that toner and paper of image forming apparatuses are consumed evenly. The balanced mode is used when neither the toner priority mode nor the paper priority mode is set.

At step S1804, the distribution unit determines whether the toner priority mode is set. When the toner priority mode is set, the process proceeds to step S1806. When the toner priority mode is not set, the process proceeds to step S1812.

At step S1806, the distribution unit determines whether the threshold mode is set. When the threshold mode is set, the process proceeds to step S1808. When the threshold mode is not set, the process proceeds to step S1810.

At step S1808, the distribution unit identifies image forming apparatuses whose current amounts of remaining toner are greater than a threshold (e.g., 10%) from selected image forming apparatuses selected by the user, and distributes the number of pages to be printed among the identified image forming apparatuses. For example, when the user selects the image forming apparatus 4000 with an amount of remaining toner of 60%, the image forming apparatus 4100 with an amount of remaining toner of 40%, and the image forming apparatus 4200 with an amount of remaining toner of 5% to execute a print job of 100 pages, the distribution unit distributes 100 pages among the image forming apparatuses 4000 and 4100. In this case, the distribution unit may distribute the number of pages among the image forming apparatuses 4000 and 4100 according to any predetermined policy as exemplified below:
Distribute according to the ratio between the amounts of remaining toner: 60 pages to the image forming apparatus 4000 and 40 pages to the image forming apparatus 4100;
Distribute evenly: 50 pages to each of the image forming apparatuses 4000 and 4100.

At step S1810, the distribution unit distributes the number of pages based on the ratios of the amounts of remaining toner of image forming apparatuses selected by the user. For example, when the user selects the image forming apparatus 4000 with an amount of remaining toner of 60%, the image forming apparatus 4100 with an amount of remaining toner of 40%, and the image forming apparatus 4200 with an amount of remaining toner of 5% to execute a print job of 100 pages, the distribution unit assigns 57 pages to the image forming apparatus 4000, 38 pages to the image forming apparatus 4100, and 5 pages to the image forming apparatus 4200 (the values are rounded) according to the ratios of the amounts of remaining toner “6:4:0.5”.

At step S1812, the distribution unit determines whether the paper priority mode is set. When the paper priority mode is set, the process proceeds to step S1814. When the paper priority mode is not set, the process proceeds to step S1820.

At step S1814, the distribution unit determines whether the threshold mode is set. When the threshold mode is set, the process proceeds to step S1816. When the threshold mode is not set, the process proceeds to step S1818.

At step S1816, the distribution unit identifies image forming apparatuses whose current amounts of remaining paper are greater than a threshold (e.g., 10%) from selected image forming apparatuses selected by the user, and distributes the number of pages to be printed among the identified image forming apparatuses. For example, when the user selects the image forming apparatus 4000 with an amount of remaining paper of 60%, the image forming apparatus 4100 with an amount of remaining paper of 40%, and the image forming apparatus 4200 with an amount of remaining paper of 5% to execute a print job of 100 pages, the distribution unit distributes 100 pages among the image forming apparatuses 4000 and 4100. In this case, the distribution unit may distribute the number of pages among the image forming apparatuses 4000 and 4100 according to any predetermined policy as exemplified below.
Distribute according to the ratio between the amounts of remaining paper: 60 pages to the image forming apparatus 4000 and 40 pages to the image forming apparatus 4100
Distribute evenly: 50 pages to each of the image forming apparatuses 4000 and 4100

At step S1818, the distribution unit distributes the number of pages based on the ratios of the amounts of remaining paper of image forming apparatuses selected by the user. For example, when the user selects the image forming apparatus 4000 with an amount of remaining paper of 60%, the image forming apparatus 4100 with an amount of remaining paper of 40%, and the image forming apparatus 4200 with an amount of remaining toner of 5% to execute a print job of 100 pages, the distribution unit assigns 57 pages (rounded) to the image forming apparatus 4000, 38 pages to the image forming apparatus 4100, and 5 pages to the image forming apparatus 4200 (the values are rounded) according to the ratios of the amounts of remaining paper “6:4:0.5”.

At step S1820, the distribution unit distributes the number of pages among image forming apparatuses selected by the user such that toner and paper of the image forming apparatuses are consumed evenly. For example, when the user selects the image forming apparatus 4000, the image forming apparatus 4100, and the image forming apparatus 4200 to execute a print job of 90 pages, the distribution unit assigns 30 pages to the image forming apparatus 4000, 30 pages to the image forming apparatus 4100, and 30 pages to the image forming apparatus 4200.

At step S1800, the process is terminated.

The above-described process makes it possible to prevent a situation where paper and toner of a particular image forming apparatus are used intensively and thereby makes it possible to use resources of multiple image forming apparatuses in a balanced manner (or evenly). This in turn makes it possible to prevent a problem where only a particular image forming apparatus often runs out of paper and toner and becomes unavailable. According to the above embodiments, multiple policies or modes for distributing the number of copies to be printed are defined to allow the user to select one of the policies or modes according to an environment where image forming apparatuses are used.

An aspect of this disclosure provides a mobile terminal device, an image forming method, and an image processing system that make it possible to efficiently use image forming apparatuses in a balanced manner.

A mobile terminal device, an image forming method, and an image processing system are described above as preferred embodiments. However, the present invention is not limited to the specifically disclosed embodiments, and variations and modifications may be made without departing from the scope of the present invention.

What is claimed is:

1. A mobile terminal device, comprising:
an imaging unit that captures an image;
a communication unit;
an apparatus information obtaining unit that communicates with and obtains status information from each of a plurality of image forming apparatuses included in the captured image via the communication unit;
an image generating unit that generates an augmented reality image by superposing, on the captured image, additional information including the obtained status information for each of the image forming apparatuses;
an operations unit that receives an operation on the augmented reality image displayed on a screen; and
a distribution unit that distributes a number of pages to be printed among the image forming apparatuses according to the received operation.

2. The mobile terminal device as claimed in claim 1, wherein the distribution unit distributes the number of pages to be printed based on the status information of each of the image forming apparatuses.

3. The mobile terminal device as claimed in claim 2, wherein the status information of each of the image forming apparatuses includes at least one of an amount of remaining toner and an amount of remaining paper.

4. The mobile terminal device as claimed in claim 3, wherein the distribution unit distributes the number of pages to be printed based on one of a ratio of the amount of remaining toner and a ratio of the amount of remaining paper of each of the image forming apparatuses.

5. The mobile terminal device as claimed in claim 3, wherein the distribution unit distributes the number of pages to be printed among the image forming apparatuses whose amounts of remaining toner or paper are greater than a threshold.

6. The mobile terminal device as claimed in claim 1, wherein the additional information includes at least one of amounts of remaining toner and amounts of remaining paper before and after a portion of the number of pages distributed by the distribution unit is printed.

7. The mobile terminal device as claimed in claim 1, wherein
the apparatus information obtaining unit obtains connection information of another image forming apparatus not included in the captured image and communicates with the other image forming apparatus based on the connection information to obtain the status information; and
the distribution unit distributes a portion of the number of pages to be printed also to the other image forming apparatus.

8. The mobile terminal device as claimed in claim 7, wherein the image generating unit displays a floor map including the image forming apparatuses and the other image forming apparatus on the screen together with the status information of each of the image forming apparatuses and the other image forming apparatus.

9. The mobile terminal device as claimed in claim 1, further comprising:
a position identifying unit that receives an indoor positioning signal including altitude information and identifies a current position of the mobile terminal device based on the indoor positioning signal.

10. The mobile terminal device as claimed in claim 1, wherein
the apparatus information obtaining unit also obtains positional information from each of the image forming apparatuses; and
the image generating unit displays sets of the additional information of the image forming apparatuses at different positions on the screen based on the positional information.

11. The mobile terminal device as claimed in claim 10, wherein the positional information of each of the image forming apparatuses is obtained by the each of the image forming apparatuses based on an indoor positioning signal including altitude information.

12. The mobile terminal device as claimed in claim 1, wherein the communication unit communicates with the image forming apparatuses via close-range radio communications.

13. A method performed by a mobile terminal device, the method comprising:
capturing an image;
communicating with and obtaining status information from each of a plurality of image forming apparatuses included in the captured image;
generating an augmented reality image by superposing, on the captured image, additional information including the obtained status information for each of the image forming apparatuses;
receiving an operation on the augmented reality image displayed on a screen; and
distributing a number of pages to be printed among the image forming apparatuses according to the received operation.

14. An image processing system, comprising:
a mobile terminal device; and
a plurality of image forming apparatuses,
wherein the mobile terminal device includes
an imaging unit that captures an image,
a communication unit,
an apparatus information obtaining unit that communicates with and obtains status information from each of the image forming apparatuses included in the captured image via the communication unit,
an image generating unit that generates an augmented reality image by superposing, on the captured image, additional information including the obtained status information for each of the image forming apparatuses,
an operations unit that receives an operation on the augmented reality image displayed on a screen, and
a distribution unit that distributes a number of pages to be printed among the image forming apparatuses according to the received operation;
wherein each of the image forming apparatuses includes
a communication unit that transmits the status information to the mobile terminal device, and
a processing unit that performs a print job for printing a portion of the number of pages distributed by the distribution unit.

15. The image processing system as claimed in claim 14, wherein each of the image forming apparatuses further includes a redistribution unit that redistributes the portion of the number of pages when another print job is received from another mobile terminal device.
